(19) United States
(12) Patent Application Publication
(10) Pub. No.: US 2026/0343378 A1
(43) Pub. Date: Oct. 29, 2026

(54) METHOD, DEVICE AND COMPUTER STORAGE MEDIUM OF COMMUNICATION

(71) Applicant: NEC CORPORATION, Tokyo (JP)

(72) Inventors: You LI, Beijing (CN); Gang WANG, Beijing (CN)

(73) Assignee: NEC CORPORATION, Tokyo (JP)

(21) Appl. No.: 19/102,575

(22) PCT Filed: Aug. 9, 2022
(86) PCT No.: PCT/CN2022/111289

§ 371 Date: Feb. 10, 2025

(51) Int. Cl. H04W 40/22; H04W 36/00; H04W 40/24; H04W 88/04

(52) U.S. Cl. CPC H04W 40/22; H04W 36/0069; H04W 40/246; H04W 88/04

(57) ABSTRACT

Example embodiments of the present disclosure relate to an effective mechanism for handing the scenario of discontinuous coverage. In this solution, the first network device transmits information on a list of relay terminal devices to a second network device; receives a first configuration message at least comprising a relay related configuration for a relaying path between the second network device and a first terminal device via a second terminal device, the first terminal device having a connection with the first network device; and transmits a second configuration message at least comprising the relay related configuration to the first terminal device for activating the relaying path. By communication relay related configuration among the related network devices and the terminal devices, the multi-path (especially a relaying path) may be well managed (including configured, activated, deceived, deleted and so on.)

### TECHNICAL FIELD

Embodiments of the present disclosure generally relate to the field of telecommunication, and in particular, to methods, devices and computer storage media for managing multi-path.

### BACKGROUND

Dual connectivity (DC) is a mode of operation where a terminal device (for example, user equipment, UE) can be configured to utilize radio resources provided by two network devices, for example, two base stations (BSs). A first network device serves the terminal device as a master node (MN), and a second network device serves the terminal device as a secondary node (SN). In the traditional DC scenario, the MN and SN may be associated with one or more serving cells usually, where the group of serving cells associated with the MN is referred to as a master cell group (MCG) and the group of serving cells associated with the SN is referred to as a secondary cell group (SCG).

In addition, a technology of multi-path is expected to be supported to enhance reliability and throughput. In this event, a terminal device is allowed to communicate with the network via both a direct path and an indirect path. However, how to manage (such as, configure, activate, deactivate and modify) the multi-path is still needed further discissions.

### SUMMARY

In general, embodiments of the present disclosure provide methods, devices and computer storage media for managing multi-path in the DC network.

In a first aspect, there is provided a method of communication. The method comprises: transmitting, at a first network device, information on a list of relay terminal devices to a second network device; receiving a first configuration message at least comprising a relay related configuration for a relaying path between the second network device and a first terminal device via a second terminal device, the first terminal device having a connection with the first network device; and transmitting a second configuration message at least comprising the relay related configuration to the first terminal device for activating the relaying path.

In a second aspect, there is provided a method of communication. The method comprises: receiving, at a first terminal device, a second configuration message at least comprising a relay related configuration for a relaying path between a second network device and a first terminal device via a second terminal device, the first terminal device having a connection with the first network device; determining whether the relaying path is to be activated at least based on the second configuration message; and in accordance with a determination that the relaying path is to be activated, performing a relaying path activation procedure.

In a third aspect, there is provided a method of communication. The method comprises: receiving, at a second network device, information on a list of relay terminal devices from a first network device; and transmitting, to the first network device, a first configuration message at least comprising a relay related configuration for a relaying path between the second network device and a first terminal device via a second terminal device, the first terminal device having a connection with the first network device, wherein at least the relay related configuration being used by the first terminal device to activate the relaying path.

In a fourth aspect, there is provided a method of communication. The method comprises: receiving, at a second terminal device and from a second network device, a configuration message associated with a relaying path between the second network device and a first terminal device via the second terminal device, the first terminal device having a connection with the first network device, the first terminal device activating the relaying path based on relay related configuration for the relaying path received from the first network device.

In a fifth aspect, there is provided a first network device. The first network device includes a processing unit; and a memory coupled to the processing unit and storing instructions thereon, the instructions, when executed by the processing unit, causing the device to perform the method according to the first aspect.

In a sixth aspect, there is provided a second network device. The first terminal device includes a processing unit; and a memory coupled to the processing unit and storing instructions thereon, the instructions, when executed by the processing unit, causing the device to perform the method according to the second aspect.

In a seventh aspect, there is provided a first terminal device. The second network device includes a processing unit; and a memory coupled to the processing unit and storing instructions thereon, the instructions, when executed by the processing unit, causing the device to perform the method according to the third aspect.

In an eighth aspect, there is provided a second terminal device. The second terminal device includes a processing unit; and a memory coupled to the processing unit and storing instructions thereon, the instructions, when executed by the processing unit, causing the device to perform the method according to the fourth aspect.

In a ninth aspect, there is provided a computer readable medium having instructions stored thereon, the instructions, when executed on at least one processor, causing the at least one processor to carry out the method according to the first to any of the fourth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A to 1F are block diagrams of a communication environment in which embodiments of the present disclosure can be implemented;

FIG. 2 illustrates a signaling chart illustrating processes for communication according to some embodiments of the present disclosure, respectively;

FIGS. 3A and 3B illustrate further signaling charts illustrating processes for communication according to some embodiments of the present disclosure, respectively;

FIGS. 4 to 8 illustrate the other signaling charts illustrating processes for communication according to some embodiments of the present disclosure, respectively;

FIG. 9 illustrates an example method of communication implemented at a first network device in accordance with some embodiments of the present disclosure;

FIG. 10 illustrates an example method of communication implemented at a first terminal device in accordance with some embodiments of the present disclosure;

FIG. 11 illustrates an example method of communication implemented at a second network device in accordance with some embodiments of the present disclosure;

FIG. 12 illustrates an example method of communication implemented at a second terminal device in accordance with some embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure.

The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further have ‘multicast/broadcast’ feature, to support public safety and mission critical, V2X applications, transparent IPv4/Ipv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, a technology of multi-path is expected to be supported to enhance reliability and throughput. In this event, a terminal device is allowed to communicate with the network via both a direct path and an indirect path. However, how to manage (such as, configure, activate, deactivate and modify) the multi-path (especially a relaying path) is still needed further discissions.

Embodiments of the present disclosure provide a solution for managing multi-path in the DC network. In the present disclosure, a first network device may transmit information on a list of relay terminal devices to a second network device. Then the first network device may receive a relay related configuration (also referred to as multipath relaying configuration) from the second network device. In particular, the relay related configuration is used for a relaying path between the second network device and a first terminal device via a second terminal device. Next, the first network device may transmit the relay related configuration to the first terminal device for activating the relaying path. By communication relay related configuration among the related network devices and the terminal devices, the multi-path (especially a relaying path) may be well managed (including configured, activated, deceived, deleted and so on.)

For ease of discussion, some terms used in the following description are listed as below:
A direct network connection: refers to one mode of network connection, where there is no relay terminal device/relay UE between a terminal device and the network device;
An indirect network connection: refers to one mode of network connection, where there is a relay terminal device/relay UE between a terminal device and the network device; also referred to as a relaying path sometimes;
A first network device: refers to a network entity, which may be either a master node (MN) or secondary node (SN). In some embodiments, if necessary, the first network device may transmit a list of relay terminal devices to another network device and receive a relay related configuration accordingly. At least based on such information, the first network device may manage a relaying path with a terminal device.
A second network device: refers to a network entity, which may be either an MN or SN. In some embodiments, the second network device may receive a list of relay terminal devices and transmit a relay related configuration accordingly. At least based on such information, the second network device may manage a relaying path with a terminal device.

A first terminal device: refers to a terminal entity, which may communicate with a network device via either a direct network connection or an indirect network connection; also referred to as a remote terminal device sometimes;
A second terminal device: refers to a terminal entity, which may be used for as a relay device for the first terminal device; also referred to as a relay terminal device sometimes;
A relaying path: refer to any of the following: a path between a network device and a first terminal device via a second terminal device or multiple second terminal devices, a path between a remote terminal device and a relay terminal device (i.e., a PC5 connection/sidelink connection/D2D connection), or a path between a relay terminal device and a network device.
An SN addition: refer to an operation of configuration SCG. For example, if the RRC Reconfiguration message includes IE of secondaryCellGroup, the terminal device performs the cell group configuration for the SCG. In this way, the SN corresponding to the SCG is added.
PC5 unicast link corresponding to one cell group (e.g. SCG or MCG) means that the terminal device (e.g. remote terminal device or relay terminal device) of the PC5 unicast link is served by at least one cell of the cell group.
Relay path corresponding to one cell group (e.g. SCG or MCG) means that the terminal device (e.g. remote terminal device or relay terminal device) of the relaying path is served by at least one cell of the cell group.

In the present discourse, terms “path related information”, “relaying path configuration”, “relay related configuration”, “multipath relaying configuration”, “multipath related configuration” may be used interchangeably. In the present discourse, terms “PC5 unicast link”, “PC5-RRC connection”, “PC5 connection”, may be used interchangeably.

Principles and implementations of the present disclosure will be described in detail below with reference to the figures.

### EXAMPLE OF COMMUNICATION NETWORK

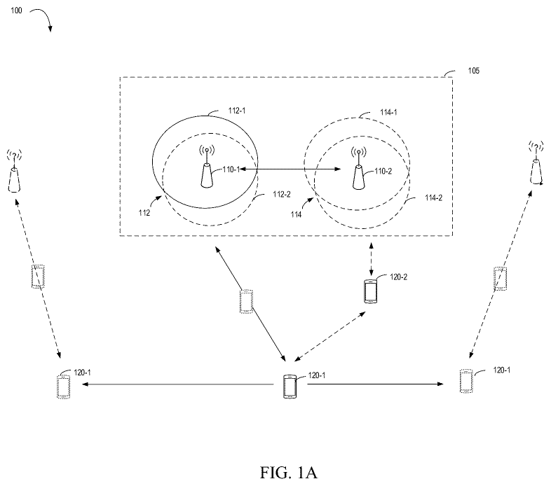

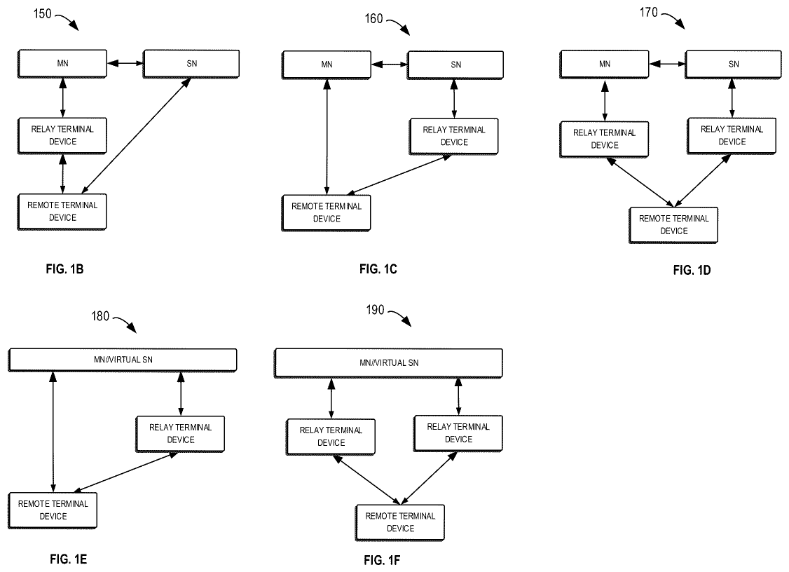

FIG. 1A shows an example communication environment 100 in which example embodiments of the present disclosure can be implemented. The communication environment 100 comprises a plurality of terminal devices and network devices. As shown in the FIG. 1A, the communication environment 100 comprise a network device 110-1, a network device 110-2 and the optional other network devices. For purpose of discussion, the network devices 110-1 and 110-2 are collectively referred to as network device 110, or individually refers to as the first network device 110-1 and the second network device 110-2, respectively.

In some embodiments, the first network device 110-1 and the second network device 120-2 are located in different physical devices. Alternatively, in some other embodiments, the first network device 110-1 and the second network device 110-2 are located in a same physical device (such as, a gNB 105 as shown in FIG. 1A). The present discourse is not limited in this regard.

Further, in some embodiments, the first network device 110-1 and the second network device 110-2 may share the same hardware resource. In this event, one of the first network device 110-1 and the second network device 110-2 may be considered as a virtual network device.

In some embodiments, one of the first network device 110 and the second network device 110-2 serves as a master node (MN) for the terminal device 120-1, and the other one serves as a secondary node (SN) for the terminal device 120-1.

It is to be understood that the DC provided by the first network device 110-1 and the second network 110-2 may comprise any suitable type of multi-radio dual connectivity (MR-DC), including but not limited to evolved universal terrestrial radio access (E-UTRA)-NR dual connectivity (EN-DC), NGEN-DC (i.e., NG-RAN E-UTRA-NR), NE-DC and NR-DC. In the case of EN-DC, the first network device 110-1 is an eNB and the second network device 110-2 is an en-gNB. In the case of NGEN-DC, the first network device 110-1 is a ng-gNB and the second network device 110-2 is a gNB. In the case of NE-DC, the first network device 110-1 is a gNB and the second network device 110-2 is a ng-gNB. In the case of NR-DC, the network devices 110 and 120 are both gNBs.

The terminal device 120-1 may communicate with the network device 110 via a direct path or an indirect path. As shown in FIG. 1A, the terminal device 120-1 (also referred to as remote UE or remote terminal device) may communicate with the second network device 110-2 via the second terminal device 120-2 (also referred to as relay UE or relay terminal device), while the terminal device 120-1 may communicate with the first network device 110-1 directly.

For purpose of discussion, the terminal devices 120-1 and 120-2 are collectively referred to as terminal device 120, or individually refers to as the remote terminal device 120-1 and the relay terminal device 120-2, respectively.

One specific scenario is discussed for better understanding. In this specific scenario, the first network device 110-1 serves the terminal device 120-1 as the MN, while the second network device 110-2 serves the terminal device 120-1 as the SN. The serving areas of the first network devices 110 and the second network device 120 are called as cells. As shown in FIG. 1A, a group of cells of the first network device 110 includes a primary cell 112-1 and an additional secondary cell (Scell) 112-2. Since the first network device 110-1 serves as the MN, the group of cells of the first network device 110-1 is referred to as MCG 112. A group of cells of the second network device 110-2 includes a primary cell 114-1 and an additional secondary cell 114-2. Since the second network device 110-2 serves as the SN, the group of cells of the second network device 110-2 is referred to as SCG 114 and the primary cell 114-1 is also referred to as PSCell 114-1.

Further, DC mode is supported in the communication environment 100. FIG. 1B to FIG. 1F illustrate three example DC scenarios 150, 160, 170, 180 and 190, respectively.

In some cases, the amount of transmission data may be increased, the terminal device 120-1 may move over time (as shown in FIG. 1A) and the channel condition of the terminal device 120-1 may become worse, which cause that the connection between the terminal device 120-1 and the network need to be changed, such as, a relaying path/SN/MN/SCG/SCG may be configured, re-configured, activated, deactivated, updated, modified, switched, deleted and so on.

An example process of an SN addition procedure is described as below.

In some embodiments, the MN (such as, the first network device 110-1) decides to request the target SN (such as, the second network device 110-2) to allocate resources for one or more specific packet data unit (PDU) sessions/quality of service (QoS) flows, indicating QoS flows characteristics (such as, QoS flow level, QoS parameters, PDU session level transport network layer (TNL) address information, and PDU session level network slice information). In addition, for bearers requiring SCG radio resources, the MN indicates the requested SCG configuration information, including the total UE capabilities and the UE capability coordination result. In this case, the MN also provides the latest measurement results for the SN to choose and configure the SCG cell(s). The MN may request the SN to allocate radio resources for split SRB operation. In NGEN-DC and NR-DC, the MN always provides all the needed security information to the SN (even if no SN terminated bearers are setup) to enable signal radio bear 3 (SRB3) to be set up based on the SN decision. The MN may request the SCG to be activated or deactivated.

In some embodiments, as for MN terminated bearer options that require Xn-U resources between the MN and the SN, the MN provides Xn-U uplink TNL address information. Alternatively, as for SN terminated bearers, the MN provides a list of available data radio bear (DRB) identifies (IDs). The S-NG-RAN node shall store this information and use it when establishing SN terminated bearers. Further, the SN may accept or reject the request.

In some embodiments, as for SN terminated bearer options that require Xn-U resources between the MN and the SN, the MN provides a list of QoS flows per PDU sessions for which SCG resources are requested to be setup upon which the SN decides how to map QoS flows to DRB.

In some embodiments, if the radio resource management (RRM) entity in the SN is able to admit the resource request, it allocates respective radio resources based on the bearer type options and respective transport network resources. For bearers requiring SCG radio resources, the SN triggers a random access for the terminal device 120-1, such that the synchronization of the SN radio resource configuration can be performed. The SN decides for the PSCell and other SCG Scells and provides the new SCG radio resource configuration to the MN within an SN RRC configuration message contained in the SN addition request acknowledge message. If the MN requested the SCG to be deactivated, the SN may keep the SCG activated. If the MN requests the SCG to be activated, the SN shall keep the SCG activated. In case of bearer options that require Xn-U resources between the MN and the SN, the SN provides Xn-U TNL address information for the respective DRB, Xn-U UL TNL address information for SN terminated bearers, Xn-U DL TNL address information for MN terminated bearers. For SN terminated bearers, the SN provides the NG-U DL TNL address information for the respective PDU Session and security algorithm. If SCG radio resources have been requested, the SCG radio resource configuration is provided.

In some embodiments, the MN sends the MN RRC reconfiguration message to the UE (such as, the terminal device 120-1) including the SN RRC configuration message, without modifying it. Within the MN RRC reconfiguration message, the MN can indicate that the SCG is deactivated.

In some embodiments, the UE applies the new configuration and replies to the MN with MN RRC reconfiguration complete message, including an SN RRC response message for SN, if needed. In case the UE is unable to comply with (part of) the configuration included in the MN RRC reconfiguration message, it performs the reconfiguration failure procedure.

In some embodiments, the MN informs the SN that the UE has completed the reconfiguration procedure successfully via SN reconfiguration complete message, including the SN RRC response message, if RRC reconfiguration complete message is received from the UE.

In some embodiments, if the UE is configured with bearers requiring SCG radio resources and the SCG is not deactivated, the UE performs synchronization towards the PSCell configured by the SN.

It is to be understood that the order of the UE sending the MN RRC reconfiguration complete message and performing the random access procedure towards the SCG is not defined. The successful random access procedure towards the SCG is not required for a successful completion of the RRC connection reconfiguration procedure.

In the following, some example process with regards to SN addition are discussed.

In some embodiment, the SCG may be activated when SN addition is performed. Specifically,
if RRC reconfiguration including the mrdc-SecondaryCellGroupConfig and if the mrdc-SecondaryCellGroupConfig is set to setup and if the received mrdc-SecondaryCellGroup is set to nr-SCG,
   perform the RRC reconfiguration for the RRCReconfiguration message included in nr-SCG;if the RRCReconfiguration includes the secondaryCellGroup:
      perform the cell group configuration for the SCG;
   if scg-State is not included the mrdc-SecondaryCellGroupConfig and if the SCG was
   deactivated before the reception of the RRCReconfiguration message,
      perform SCG activation procedure,
         indicate to lower layers that the SCG is activated,
         MAC layer check whether RA procedure is need,
         if lower layers indicate that a Random Access procedure is needed for SCG activation:
         initiate the Random Access procedure on the PSCell.

In some embodiment, the SCG may be activated without SN message.

Specifically,
if the UE is in NR-DC and if the RRCReconfiguration does not include the mrdc-SecondaryCellGroupConfig and if the RRCReconfiguration does not include the scg-State,
   perform SCG activation without SN message.

In some embodiment, the SCG may be deactivated via RRC message.

Specifically,
if the UE is in NR-DC and if the RRCReconfiguration does not include the mrdc-SecondaryCellGroupConfig and if the RRCReconfiguration includes the scg-State,
   perform SCG deactivation,
      MAC layer perform SCG deactivation,
         Reset MAC.

In some embodiment, an Scell may be activated or deactivated via MAC CE.

In the following, some further example processes of SN addition and SCG activation will be discussed.

In some embodiment, the SCG may be activated when SN addition is performed. Specifically,
1> if the RRCReconfiguration includes the secondaryCellGroup:
   2> perform the cell group configuration for the SCG;
1> if the RRCReconfiguration includes the mrdc-SecondaryCellGroupConfig:
   2> if the mrdc-SecondaryCellGroupConfig is set to setup:
      3> if the mrdc-SecondaryCellGroupConfig includes mrdc-ReleaseAndAdd:
         4> perform MR-DC release;
      3> if the received mrdc-SecondaryCellGroup is set to nr-SCG:
         4> perform the RRC reconfiguration for the RRCReconfiguration message included in nr-SCG;
      3> if the received mrdc-SecondaryCellGroup is set to eutra-SCG:
         4> perform the RRC connection reconfiguration for the RRCConnectionReconfiguration message included in eutra-SCG;
   2> else (mrdc-SecondaryCellGroupConfig is set to release):
      3> perform MR-DC release.

In some embodiment, the SCG activation may be triggered as below,
1> if the RRCReconfiguration message was received via SRB1 within the nr-SCG within mrdc-SecondaryCellGroup (in case of NR-DC, mrdc-SecondaryCellGroup was received by the UE in RRCReconfiguration or RRCResume via SRB1):
   2> if the RRCReconfiguration is applied due to a conditional reconfiguration execution for conditional PSCellChange (CPC) which is configured via conditionalReconfiguration contained in nr-SCG within mrdc-SecondaryCellGroup:
      3>submit the RRCReconfigurationComplete message via the NR MCG embedded in NR RRC message ULInformationTransferMRDC,
   2> if the scg-State is not included in the RRCReconfiguration or RRCResume message containing the RRCReconfiguration message:
      3> if the SCG was deactivated before the reception of the NR RRC message containing the RRCReconfiguration message:
         4> perform SCG activation.
      3> if reconfigurationWithSync was included in spCellConfig in nr-SCG:
         4> initiate the random access procedure on the PSCell;
      3> else if the SCG was deactivated before the reception of the NR RRC message containing the RRCReconfiguration message:
         4> if bfd-and-RLM was not configured to true before the reception of the RRCReconfiguration or RRCResume message containing the RRCReconfiguration message; or
         4> if lower layers indicate that a random access procedure is needed for SCG activation:
         5> initiate the random access procedure on the PSCell.

In some embodiments, the SCG activation is initiated if the UE is configured with an SCG after receiving the message for which this procedure is initiated and further if the UE was configured with a deactivated SCG before receiving the message for which this procedure is initiated. Specifically, the UE considers the SCG to be activated, resumes performing radio link monitoring on the SCG, if previously stopped, indicates to lower layers to resume beam failure detection on the PSCell, if previously stopped, and indicates to lower layers that the SCG is activated.

In some embodiments, the MAC entity also may set some configurations for the SCG activation. Specifically,
1> if upper layers indicate that SCG is activated:
   2> if BFI_COUNTER >=beamFailureInstanceMaxCount for the PSCell or the timeAlignmentTimer associated with PTAG is not running:
      3>indicate to upper layers that a random access procedure is needed for SCG activation,
   2> else:
      3>activate the SCG according to the timing for direct SCG activation,
   2> (re-) initialize any suspended configured uplink grants of configured grant Type 1 associated with this PSCell according to the stored configuration, if any, and to start in the symbol according to rules;
   2> apply normal SCG operation including:
      3>SRS transmissions on the PSCell;
      3>CSI reporting for the PSCell;
      3>PDCCH monitoring on the PSCell;
      3>PUCCH transmissions on the PSCell;
      3>transmit on RACH on the PSCell;
      3>initialize Bj for each logical channel to zero.

In some embodiments, the SCG may be activated without SN message. In one specific embodiment, the SCG may be activated if the UE is configured with E-UTRA nr-SecondaryCellGroupConfig (in case of (NG) EN-DC). Alternatively, in another specific embodiment, the SCG may be activated if the RRCReconfiguration message was received via SRB1 within the nr-SCG within mrdc-SecondaryCellGroup (in case of NR-DC, mrdc-SecondaryCellGroup was received in RRCReconfiguration or RRCResume via SRB1). Alternatively, in a further specific embodiment, the SCG may be activated if the RRCReconfiguration message was received via SRB3 (in case of NR-DC).

In some embodiments, the SCG activation may be trigger without SN message. Specifically,
1> if RRCReconfiguration was received via SRB1:
   2> if the UE is in NR-DC and;
   2> if the RRCReconfiguration does not include the mrdc-SecondaryCellGroupConfig:
      3> if the RRCReconfiguration includes the scg-State:
         4> perform SCG deactivation;
      3> else:
         4> perform SCG activation without SN message; not include scg-State.
   2>submit the RRCReconfigurationComplete message via SRB1 to lower layers for transmission using the new configuration;
   2> if this is the first RRCReconfiguration message after successful completion of the RRC re-establishment procedure:
      3>resume SRB2, SRB4, DRBs, multicast radio bearer (MRB), and backhaul (BH) radio link control (RLC) channels for integrated access and backhaul (IAB)-mobile terminal (MT), that are suspended.

In some embodiments, the SCG activation is initiated if the SCG was deactivated before the reception of the RRCReconfiguration message or the E-UTRA RRCConnectionReconfiguration message. Specifically,
1> consider the SCG to be activated;
1> indicate to lower layers that the SCG is activated;
1> if bfd-and-RLM was not configured to true before the reception of the RRCReconfiguration message or the E-UTRA RRCConnectionReconfiguration message for which the procedure invoking this clause is executed; or
1> if lower layers indicate that a random access procedure is needed for SCG activation:
   2> initiate the random access procedure on the PSCell.

In some embodiments, the SCG deactivation is triggered if the RRCReconfiguration message was received via SRB1 within the nr-SCG within mrdc-SecondaryCellGroup (in case of NR-DC, mrdc-SecondaryCellGroup was received in RRCReconfiguration or RRCResume via SRB1). Alternatively, in some embodiments, the SCG deactivation is triggered if the RRCReconfiguration message was received via SRB3 (in case of NR-DC).

In some embodiments, the SCG deactivation may be performed as below:
1> if RRCReconfiguration was received via SRB1:
   2> if the UE is in NR-DC and;
   2> if the RRCReconfiguration does not include the mrdc-SecondaryCellGroupConfig:
      3> if the RRCReconfiguration includes the scg-State:
         4> perform SCG deactivation;
      3> else:
         4> perform SCG activation without SN message;
   2>submit the RRCReconfigurationComplete message via SRB1 to lower layers for transmission using the new configuration;
   2> if this is the first RRCReconfiguration message after successful completion of the RRC re-establishment procedure:
      3>resume SRB2, SRB4, DRBs, multicast MRB, and BH RLC channels for IAB-MT, that are suspended.

In some embodiments, upon initiating the SCG deactivation procedure, the UE shall:
1> consider the SCG to be deactivated;
1> indicate to lower layers that the SCG is deactivated;
1> if bfd-and-RLM is configured to true:
   2> perform radio link monitoring on the SCG;
   2>indicate to lower layers to perform beam failure detection on the PSCell;
1> else:
   2>stop radio link monitoring on the SCG;
   2>indicate to lower layers to stop beam failure detection on the PSCell;
   2>stop timer T310 for this cell group, if running;
   2>stop timer T312 for this cell group, if running;
   2>reset the counters N310 and N311.

In some embodiments, when performing the SCG deactivation, for the configured SCG, the MAC entity shall:
1> if upper layers indicate that the SCG is deactivated:
   2>deactivate all the Scells of the SCG;
   2>deactivate SCG according to the timing;
   2>clear any configured downlink assignment and any configured uplink grant Type 2 associated with the PSCell respectively;
   2>suspend any configured uplink grant Type 1 associated with the PSCell;
   2>reset MAC.
1> if the SCG is deactivated:
   2>not transmit SRS on the PSCell;
   2>not report CSI for the PSCell;
   2>not transmit on UL-SCH on the PSCell;
   2>not transmit PUCCH on the PSCell;
   2>not transmit on RACH on the PSCell;
   2>not monitor the PDCCH on the PSCell.

In some embodiments, when performing the SCG deactivation, the MAC may be reset. Specifically, if a sidelink specific reset of the MAC entity is requested for a PC5-RRC connection by upper layers, the MAC entity shall: flush the soft buffers for all sidelink processes for all transport block(s) (TB(s)) associated to the PC5-RRC connection; consider all sidelink processes for all TB(s) associated to the PC5-RRC connection as unoccupied cancel, if any, triggered Scheduling Request procedure only associated to the PC5-RRC connection; cancel, if any, triggered Sidelink Buffer Status Reporting procedure only associated to the PC5-RRC connection; cancel, if any, triggered Sidelink CSI Reporting procedure associated to the PC5-RRC connection; stop (if running) all timers associated to the PC5-RRC connection; reset the numConsecutiveDTX associated to the PC5-RRC connection; and initialize SBj for each logical channel associated to the PC5-RRC connection to zero.

In the above example embodiments, the information element (IE) mrdc-SecondaryCellGroup and CellGroupConfig may be used for SGC activation. In some embodiments, the mrdc-SecondaryCellGroup and CellGroupConfig may include an RRC message for SCG configuration in NR-DC or NE-DC. As one example, in case of NR-DC (i.e., nr-SCG), mrdc-SecondaryCellGroup contains the RRCReconfiguration message as generated (entirely) by SN gNB. In this specific example, the RRC message can only include fields secondaryCellGroup, otherConfig, conditionalReconfiguration, measConfig, bap-Config and IAB-IP-AddressConfigurationList.

As discussed above, SCG activation and deactivation may be enabled by Ies in the RRC message. For better understanding, one example of part of the RRC message and CellGroupConfig IE are illustrated as below.

| | |
|---|---|
| RRCReconfiguration-IEs ::= | SEQUENCE { |

[symbol]

| | | |
|---|---|---|
| secondaryCellGroup | OCTET STRING (CONTAINING CellGroupConfig) | OPTIONAL, -- Cond SC [symbol] |

[symbol]

}

[symbol]

| RRCReconfiguration-v [symbol] -IEs ::= | SEQUENCE { | |
|---|---|---|
| [symbol] -secondaryCellGroupConfig | SetupRelease { [symbol] -SecondaryCellGroupConfig } | OPTIONAL, -- Need N |

[symbol]

}

[symbol]

| | |
|---|---|
| [symbol] configuration-v17 [symbol] -IEs ::= | SEQUENCE { |

[symbol]

| | | |
|---|---|---|
| [symbol] -State-r17 | ENUMERATED { deactivated } | OPTIONAL, -- Need N |

[symbol]

[symbol]

| [symbol] CellGroupConfig ::= | SEQUENCE { | |
|---|---|---|
| [symbol] -Release [symbol] | ENUMERATED {true} | OPTIONAL, -- Need N |

| | |
|---|---|
| [symbol] -SecondaryCellGroup | CHOICE { |
| [symbol] | [symbol] STRING (CONTAINING [symbol] configuration), |
| eutra-S [symbol] | OCTET STRING |

}
} [symbol]
indicates data missing or illegible when filed

For NR-DC (nr-SCG), mrdc-SecondaryCellGroup contains the RRCReconfiguration message as generated (entirely) by SN gNB. In this version of the specification, the RRC message can only include fields secondaryCellGroup, otherConfig, conditionalReconfiguration, measConfig, bap-Config and IAB-IP-AddressConfigurationList.

### Example of Part of Cellgroupconfig IE

| CellGroupConfig ::= | SEQUENCE { | |
|---|---|---|
| cellGroupId | CellGroupId, | |
| rlc- [symbol] ToAdd [symbol] | SEQUENCE (SIZE(1..maxLC-ID)) OF [symbol] Config | OPTIONAL, -- Need [symbol] |
| rlc- [symbol] ToReleaseList | SEQUENCE (SIZE(1..maxLC-ID)) OF LogicalChannelIdentity | OPTIONAL, -- Need [symbol] |
| [symbol] -CellGroupConfig | MAC-CellGroupConfig | OPTIONAL, -- Need [symbol] |
| physicalCellGroupConfig | PhysicalCellGroupConfig | OPTIONAL, -- Need [symbol] |
| spCellConfig | SpCellConfig | OPTIONAL, -- Need [symbol] |
| [symbol] Cell [symbol] List | SEQUENCE (SIZE (1.. [symbol] Nrof [symbol] Cells)) OF [symbol] CellConfig | OPTIONAL, -- Need [symbol] |
| [symbol] CellToReleaseList | SEQUENCE (SIZE (1..maxNrof [symbol] Cells)) OF [symbol] CellIndex | OPTIONAL, -- Need [symbol] |

[symbol]

[symbol]

| | | |
|---|---|---|
| [symbol] -r17 | ENUMERATED { [symbol] , [symbol] , [symbol] } | OPTIONAL, -- Need [symbol] |
| uplink [symbol] -Node-r17 | ENUMERATED {enabled} | OPTIONAL, -- [symbol] |
| uplink [symbol] -DuelUL-TxState-r17 | ENUMERATED {oneT, [symbol] } | OPTIONAL, -- [symbol] |

| | |
|---|---|
| [symbol] -RelayRLC-Channel [symbol] List-r17 | SEQUENCE (SIZE(1..max [symbol] -ChannelID- [symbol] OF [symbol] -Relay [symbol] -ChannelConfig-r17 |

OPTIONAL, -- Need

[symbol]

| | |
|---|---|
| [symbol] -RelayRLC-ChannelToReleaseList-r17 | SEQUENCE (SIZE(1.. [symbol] -Relay [symbol] -ChannelID-r17)) OF [symbol] -RelayRLC-ChannelID-r17 |

OPTIONAL, -- Need

[symbol]

[symbol]

[symbol]

} [symbol]
indicates data missing or illegible when filed

As discussed above, the terminal device 120-1 (also referred to as remote UE or remote terminal device) may communicate with the second network device 110-2 via the second network device 110-2 (also referred to as relay UE or relay terminal device). In the following, some example processes with regards to establishing a relaying path are discussed.

In some embodiments, the layer 2 (L2) user to network (U2N) remote UE (such as, the terminal device 120-1 as illustrated in FIG. 1A) reports one or multiple candidate L2 U2N relay UE(s) and Uu measurements, after it measures/discovers the candidate L2 U2N relay UE(s).

In some embodiments, the gNB (such as, gNB 105 as illustrated in FIG. 1A) decides to switch the L2 U2N remote UE to a target L2 U2N relay UE (such as, the terminal device 120-2 as illustrated in FIG. 1A). Then the gNB sends an RRCReconfiguration message to the target L2 U2N relay UE, which includes at least L2 U2N Remote UE's local ID and L2 ID, Uu and PC5 relay RLC channel configuration for relaying, and bearer mapping configuration.

In some embodiments, the gNB sends the RRCReconfiguration message to the L2 U2N Remote UE. The RRCReconfiguration message includes at least L2 U2N relay UE ID, remote UE's local ID, PC5 relay RLC channel configuration for relay traffic and the associated end-to-end radio bearer(s). The L2 U2N remote UE stops user plane (UP) and control plane (CP) transmission over Uu after reception of RRCReconfiguration message from the gNB.

In some embodiments, the L2 U2N remote UE establishes PC5 RRC connection with target L2 U2N Relay UE.

In some embodiments, the L2 U2N remote UE completes the path switch procedure by sending the RRCReconfigurationComplete message to the gNB via the L2 U2N Relay UE.

In some embodiments, the data path is switched from direct path to indirect path between the L2 U2N Remote UE and the gNB.

In some embodiments, in case the selected L2 U2N Relay UE for direct to indirect path switch is in RRC_IDLE or RRC_INACTIVE, after receiving the path switch command, the L2 U2N Remote UE establishes a PC5 link with the L2 U2N Relay UE and sends the RRCReconfigurationComplete message via the L2 U2N Relay UE, which triggers the L2 U2N relay UE to enter RRC_CONNECTED state.

It is to be understood that the above procedure for L2 U2N remote UE switching to indirect path can be also applied for the case that the selected L2 U2N relay UE for direct to indirect path switch is in RRC IDLE or RRC INACTIVE with the exception the RRCReconfiguration message is sent from the gNB to the L2 U2N relay UE after the L2 U2N relay UE enters RRC_CONNECTED state.

In addition, the relaying path may be released or recovered or maintained. In some embodiments, upon receiving a NotificationMessageSidelink, the U2N remote UE (such as, the terminal device 120-2) shall:
1> if the indicationType is included:
   2> if the UE is L2 U2N Remote UE in RRC_CONNECTED:
      3> initiate the RRC connection re-establishment procedure;
   2> else (the UE is layer3 (L3) U2N Remote UE, or L2 U2N Remote UE in RRC_IDLE or RRC_INACTIVE):
      3> if the PC5-RRC connection with the U2N Relay UE is determined to be released:
         4> perform the PC5-RRC connection release.
      3> else:
         4>maintain the PC5-RRC connection;
         4> if the UE is L2 U2N Remote UE and the indicationType is relayUE-HO or relayUE-CellReselection:
         5>consider cell re-selection occurs.

In some embodiments, timer T304 is used for controlling sync failure of reconfiguration while timer T420 is used for controlling a path switch failure. Specifically, if T304 of the MCG expires, or if T420 expires, or if the target L2 U2N relay UE (i.e., the UE indicated by targetRelayUE-Identity in the received RRCReconfiguration message containing reconfigurationWithSync indicating path switch) changes its serving Pcell before path switch, the remote UE performs:
if any DAPS bearer is configured, and radio link failure is not detected in the source Pcell: else:
   revert back to the UE configuration used in the source Pcell;
   if the associated T304 was not initiated upon cell selection performed while timer T311 was running:
      store the handover failure information in VarRLF-Report;
   initiate the connection re-establishment procedure.

In some embodiments, when the remote UE (such as, the terminal device 120-1) detects a sidelink failure (such as, upon indication from sidelink RLC entity that the maximum number of retransmissions for a specific destination has been reached; upon T400 expiry for a specific destination; upon indication from MAC entity that the maximum number of consecutive HARQ DTX for a specific destination has been reached; or upon integrity check failure indication from sidelink PDCP entity concerning SL-SRB2 or SL-SRB3 for a specific destination), the remote UE performs the following:
consider sidelink radio link failure to be detected for this destination;
release the DRBs of this destination;
release the SRBs of this destination;
release the PC5 Relay RLC channels of this destination if configured;
discard the NR sidelink communication related configuration of this destination;
reset the sidelink specific MAC of this destination;
consider the PC5-RRC connection is released for the destination;
indicate the release of the PC5-RRC connection to the upper layers for this destination (i.e. PC5 is unavailable);
if UE is in RRC CONNECTED:
   if the UE is acting as L2 U2N Remote UE:
      initiate the RRC connection re-establishment procedure.
   else:
      perform the sidelink UE information for NR sidelink communication procedure;

In some embodiments, the sidelink may be released by upper layers (such as, RRC layer) or AS layer. The UE initiates to release the sidelink when upper layers request the release of the PC5-RRC connection or when AS layer releases the PC5-RRC connection. Additionally, the UE shall not initiate the procedure for power saving purposes.

Additionally, in some embodiments, if the PC5-RRC connection release for the specific destination is requested by upper layers, the remote UE may discard the NR sidelink communication related configuration of this destination, release the DRBs of this destination if configured, release the SRBs of this destination, release the PC5 Relay RLC channels if configured, reset the sidelink specific MAC of this destination, and consider the PC5-RRC connection is released for the destination.

Alternatively, in some embodiments, if the PC5-RRC connection release is initiated at the AS, the remote UE may indicate the upper layers the PC5-RRC connection is released for the destination.

It should be appreciated that the numbers and types of devices in FIGS. 1A to 1F are given for the purpose of illustration without suggesting any limitations to the present disclosure. The communication environment 100 may include any suitable number of network devices and/or terminal devices adapted for implementing implementations of the present disclosure. Further, the communication environment 100 may include any other devices than the network devices and the terminal devices, such as a core network element, but they are omitted here so as to avoid obscuring the present invention.

In some embodiments, the terminal device 120 and the network device 110 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example Processed for Path Management

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 120 and the network device 110 (such as, exchanging configuration(s) and so on). It is to be understood that the interactions may be implemented either in one single signaling/message or multiple signaling/messages, including system information, radio resource control (RRC) message, downlink control information (DCI) message, uplink control information (UCI) message, media access control (MAC) control element (CE), sidelink relay adaptation protocol (SRAP) and so on. The present disclosure is not limited in this regard.

It is to be understood that in the following, although some example operations are described with regards to an MN device, because under a DC mode, both the MN and SN may communicate with the terminal decide and may in charge of network managements, the operations described with regards to an MN device also may be adaptable to the SN. Merely for brevity, some similar contents are omitted herein.

Further, it is to be understood that in the following, although some example operations are described with regards to a scenario of path activation/addition, because the path managements are similar, example operations described with regards to a scenario of path activation/addition also may be adaptable to scenarios of path deactivation, modification and other scenario. Further, although a scenario of SN/SCG addition is described in some example embodiments, the scenario of SN/SCG addition also may be replaced by other scenarios based on the teaching of the below discussed example embodiments, the other scenarios including but not limited to, MN/MCGSN/SCG modification, MN/MCGSN/SCG activation, MN/MCGSN/SCG deactivation and so on. In summary, such changes should also be considered within the scope of this disclosure.

Principle and implementations of the present disclosure will be described in detail below with reference to FIG. 2, which shows a signaling chart illustrating a process 200 of communication according to some example embodiments of the present disclosure. For the purpose of discussion, the process 200 will be described with reference to FIGS. 1A to 1F.

The process 200 may involve the first network device 110-1, the second network device 110-2, the first terminal device 120-1 and the second terminal device 120-2. Further, the process 200 may optionally involve some other first network devices and other second network devices.

In the specific embodiment of FIG. 2, the first terminal device 120-1 has a connection with the first network device 110-1.

In operation, the first network device 110-1 transmits 205 information on a list of relay terminal devices to a second network device 110-2.

In some embodiments, the list of relay terminal devices comprises identifications of the list of relay terminal devices. Alternatively, in some embodiments, the list of relay terminal devices comprises measurement results about the list of relay terminal devices.

Next, the first network device 110-1 receives 210 a first configuration message at least comprising a relay related configuration for a relaying path between the second network device 110-2 and a first terminal device 120-1 via a second terminal device 120-2.

In one specific example, the first configuration message is received from the second network device 110-2. Specifically, the second network device 110-2 receives information on a list of relay terminal devices from the first network device 110-1, and transmits the first configuration message to the first network device 110-1. Alternatively, in another specific example, such as in a scenario of MN handover/modification, the first network device 110-1 may receive the first configuration message from other first/second network device (such as, target MN). It is to be understood that the first network device 110-1 may receive the first configuration message from any suitable device according to the specific application scenario. The present discourse is not limited in this regard.

In the present discourse, parameters for managing the relaying path may be comprised in the relay related configuration. One example parameter is an identification of the second terminal device 120-2. Another example parameter is a local identification of the first terminal device 120-1. A further example parameter is a PC5 relay RLC channel configuration for relay traffic. The other example parameters, include but are not limited to an associated end-to-end radio bearer, an identification of the relaying path, and an identification of relay related configuration.

It should be appreciated that the above example parameters are given for the purpose of illustration without suggesting any limitations. The relay related configuration may comprise any suitable parameters. Further, the above parameters and the other suitable parameters may be used separately or in combination.

Further, as discussed above, the MN and the SN may share same hardware resource. In this event, one of the first network device 110-1 and the second network device 110-2 may be a treated as a virtual device. If so, the second configuration may comprise related information to indicate the virtual device. In some embodiments, the first network device 110-1 comprises an MN and an SN (i.e., the SN may be treated as a virtual SN. In other word, the MN are treated as SN), and the second configuration message further comprises a predetermined value or an indicator indicating a virtual SN.

Alternatively, in some embodiments, the second configuration message only comprises the relay related configuration, or the second configuration message indicates that a spCell of the MN is set as a spCell of the SN.

In some embodiments, in case of virtual SN, the first terminal device 120-1 may use configurations for the first network device 110-1 as configurations for the second network device 110-2.

Next, the first network device 110-1 may use the information comprised in the configuration message to manage the relaying path as discussed below.

In some embodiments, the first network device 110-1 generates and transmits 215 a second configuration message at least comprising the relay related configuration to the first terminal device 120-1.

In some embodiments, the first terminal device 120-1 may use the relay related configuration to maintain (such as, activate, deactivate, modify and so on) the relaying path, which will be discussed in detail in the following parts of the present discourse. Additionally, the first terminal device 120-1 may feedback 220 a second configuration complete message corresponding to the second configuration message. The first network device 110-1 may transmits 225 a first configuration complete message corresponding to the first configuration message to the second network device 110-2.

Additionally, in some embodiments, the first network device 110-1 comprises a MN and the second network device 110-2 comprises a SN, and both of the first and second configuration complete messages comprise SN Radio Resource Control (RRC) response message for the SN.

In some embodiments, the above discussed processes may be implemented in a scenario of SN addition. In this event, the information on the list of relay terminal devices id comprised in an SN addition request, the first configuration message is comprised in an SN addition request acknowledgement message.

Alternatively, the above discussed processes may be implemented in a scenario of SN modification. In this event, the information on the list of relay terminal devices is comprised in an SN modification request, the first configuration message is comprised in an SN modification request acknowledgement message.

Alternatively, in some embodiments, the above discussed processes may be implemented in a scenario of handover. In this event, the first network device 110-1 comprises a source MN, the second network device 110-2 comprises a target MN. Further, the information on the list of relay terminal devices is comprised in a handover request, the first configuration message is comprised in a handover request acknowledgement message.

Alternatively, in some embodiments, the above discussed processes may be implemented in a scenario of handover. In this event, the first network device 110-1 comprises a source MN, the second network device 110-2 comprises a target SN which is to be changed from a source SN. In this specific example, the first network device 110-1 transmits the information on the list of relay terminal devices in a handover request to a target MN, and the information on the list of relay terminal devices is transmitted from the target MN to the target SN in an SN addition request. Alternatively, or in addition, a subset of the list of relay terminal devices is transmitted from the target MN to the target SN in an SN addition request. In other words, the target MN may perform relay terminal device selection for the target SN. Further, the first network device 110-1 receives the first configuration message in a handover request acknowledgement message from the target MN, where the first configuration message is received at the target MN from the target SN in an SN addition request acknowledgement message.

It is to be understood that the example scenarios are only for the purpose of illustration without suggesting any limitations.

In addition to being suitable to any suitable scenario, the above discussed processes also may be implemented by combining with of SCG/MCG related processes as discussed below.

In some embodiments, the first configuration message further comprises an SCG radio resource configuration and the second configuration message further comprises the SCG radio resource configuration. In this event, the first network device 110-1 may further determine whether a relaying path is deactivated based on the SCG radio resource configuration. In case that the relaying path is deactivated (such as, the SCG is currently deactivated), the first network device 110 may activate the relaying path by transmitting an activation indication to the first terminal device 120-1. Additionally, the SCG may also be activated as the result that the relaying path is activated. Alternatively, or in addition, the second network device 110-2 may activate the relaying path by transmitting an activation indication to the first terminal device 120-1 via the relay relate configuration or request the first network device 110-1 to activate the relaying path by transmitting an activation indication to the first terminal device 120-1 from the first network device 110-1.

In some embodiments, the activation indication is transmitted 235 via an MAC CE. Alternatively, in some embodiments, the activation indication is transmitted via an RRC signaling. Alternatively, in some embodiments, the activation indication is transmitted via an SRAP control information. Alternatively, in some embodiments, the activation indication is transmitted via a layer 2 signalling. Alternatively, in some embodiments, the activation indication is transmitted via a physical layer signalling, such as DCI (Downlink Control Information) and SCI (Sidelink Control Information).

As for the first terminal device 120-1, after receiving the second configuration, the first terminal device 120-1 may determine 240 whether the relaying path is to be activated at least based on the second configuration message. Further, if the first terminal device 120-1 determines that the relaying path is to be activated, the first terminal device 120-1 performs 245 a relaying path activation procedure.

In some embodiments, the second configuration message further comprises an SCG radio resource configuration or an indication about whether the SCG is deactivated (e.g. scg-State). In this event, if the SCG radio resource configuration or the indication indicates that the relaying path is not deactivated (e.g the SCG radio resource configuration indicates that the SCG is not deactivated, or the indication indicates that the SCG is not deactivated) and at least one relay terminal device is indicated in the relay related configuration and/or the an activation indication is indicated in the second configuration message, the first terminal device 120-1 may determine that the relaying path is to be activated.

Alternatively, in some embodiments, in response to receiving an activation indication for activating the relaying path from the first network device, the first terminal device 120-1 may determine that the relaying path is to be activated.

In some embodiments, the relaying path activation may be performed through one or more phases, at least including loading relaying path configuration, such as applying the configuration of PC5 RLC relay channel for the relaying path, and activating relaying path. Further, these phases may be performed during a same time period, or performed during different time periods. For example, the, the first terminal device 110-1 may load relaying path configuration in response receiving the second configuration and activate the relaying path when determining that it is needed to activate the relaying path (such as, receiving an activation indication in MAC CE). Alternatively, the first terminal device 110-1 may load relaying path configuration and activate relaying path in response receiving an activation indication in MAC CE. Thus, in some embodiments, performing a relaying path activation procedure comprises applying the relaying related configuration for data transmission. Alternatively, or in addition, in some embodiments, performing a relaying path activation procedure comprises requesting an upper layer to initiate PC5 connection establishment with the second terminal device. Alternatively, or in addition, in some embodiments, performing a relaying path activation procedure comprises indicating to a lower layer that the relaying path is activated or a SCG is activated with the relaying path.

Further, as for the second network device 110-2, except transmitting the first configuration message to the first network device 110-1, the second network device 110-2 also may activate a relaying path for a relay terminal device (i.e., the second terminal device 120-2). In some embodiments, the second network device 110-2 transmits 230 a configuration message associated with the relaying path to the second terminal device 120-2.

The configuration message may comprise any suitable parameters used for managing a relaying path for a relay terminal device. One example parameter is a local identification or an L2 identification of the second terminal device 120-2. Another example parameter is an Uu and PC5 Relay RLC channel configuration for relaying. The other example parameter include but are not limited to a bearer mapping configuration, and an identification of the relaying path.

Additionally, in some embodiments, the configuration message comprises an indication indicating whether the configuration of the relaying path for the first terminal device is to be activated. Alternatively, or in addition, in some embodiments, the configuration message may be sent if the first network device 110-1 or the second network device 110-2 determines to activate the relaying path of the first terminal device 120-1. Alternatively, or in addition, in some embodiments, the configuration message may be sent after/upon the relaying path of the first terminal device 120-1 is activated.

It is to be understood that the relaying path management procedures for the relay terminal device (i.e., the second terminal device 120-2) are similar with those for the remote terminal device (i.e., the first terminal device 120-1). For example, may be managed via one of more messages, including RRC message, MAC CE and so on. Further, the processes for activating the relaying path at the second terminal device 120-2 are similar with those at the first terminal device 120-1, which means that loading relaying path configuration and activating relaying path may be performed separately. Merely for brevity, similar contents are omitted here.

According to the above processes, the relaying path may be established 255. Specifically, a PC5 connection is established between the first terminal device 120-1 and the second terminal device 120-2 if needed, and the Uu connection is established between the second terminal device 120-2 and the second network device 110-2 if needed. In which ‘if needed’ means that the corresponding connection is not established yet.

In some embodiments, the relaying path also may be deactivated 260. In some embodiments, the deactivation procedure is initiated by the first network device 110-1 (for example, an MN). As illustrated in FIG. 2, the first network device 110-1 transmits 260-1 to the first terminal device 120-1 a deactivation indication for deactivating the relaying path.

Alternatively, the deactivation procedure also may be initiated by the second network device 110-2 (for example, an SN), such as based on the indication sent from the second network device 110-2 to the first terminal device 120-1 or based on the indication sent from the first network device 110-1 to the first terminal device 120-1 which is requested by the second network device 110-2. As illustrated in FIG. 2, the second network device 110-2 transmits 260-2 to the first terminal device 120-1 a deactivation indication for deactivating the relaying path.

In some embodiments, in response to receiving a deactivation indication for deactivating a relaying path, the first terminal device 110-1 releases a PC5-RRC connection for the relaying path.

Alternatively, in some embodiments, in response to receiving a deactivation indication for deactivating a relaying path, the first terminal device 110-1 suspends a transmission via a PC5 connection of the relaying path, and controls reception and transmission of a discovery message with a separate indicator.

In some cases, the relaying path may be failed. If so, a RLF related procedure also may be performed 270. As illustrated in FIG. 2, if the first terminal device 120-1 detects/determines 274 an RLF, the first terminal device 120-1 may transmits 276 failure information associated with the relaying path to the first network device 110-1.

Further, such relaying path failure may occur during a configuration phase. In this event, the failure information is about SCG RLF during configuration procedure of the relaying path.

Alternatively, the first terminal device 120-1 may determine the relaying path failure in response to an upper layer indicates a failure of PC5 connection establishment corresponding to a SCG and/or a SN or after N times of retry of PC5 connection establishment corresponding to the SCG and/or SN.

Alternatively, the first terminal device may determine the relaying path failure if RLF of a PC5 unicast link is detected and if this PC5 unicast link is corresponding to the SCG and/or SN.

Alternatively, the first terminal device 120-1 may determine the relaying path failure in response to receiving 272 a NotificaitonMessageSidelink message from the second terminal device 120-2.

In the present discourse, the failure information may comprise any suitable information to indicate the RLF as discussed below.

In some embodiments, the failure information comprises at least one of:
a SCG RLF cause related to a failure of PC5 connection establishment,
an identification of the second terminal device 120-2, an identification of corresponding Scell of SCG,
an identification of the relaying path, or an identification of a multipath relaying configuration.

Alternatively, in some embodiments, the failure information comprises at least one of:
a RLF cause related to a sidelink failure,
T400 expiry for a predetermined destination,
a maximum number of consecutive hybrid automatic repeat request (HARQ) discontinuous transmission (DTX) for a predetermined destination,
an integrity check failure concerning SL-SRB2 or SL-SRB3 for a specific destination,
an identification of the second terminal device 120-2,
an identification of corresponding Scell of SCG,
an identification of the relaying path, or an identification of a multipath relaying configuration.

Alternatively, in some embodiments, the failure information comprises at least one of:
a RLF cause related to a Uu failure,
the second terminal device 120-2 detecting Uu RLF,
the second terminal device 120-2 receiving an RRCReconfiguration including the reconfiguration WithSync,
the second terminal device 120-2 performing cell reselection, the second terminal device's RRC connection failure including RRC connection reject,
T300 expiry,
an RRC resume failure,
an identification of the second terminal device 120-2,
an identification of corresponding Scell of SCG,
an identification of the relaying path, or
an identification of a multipath relaying configuration

In this way, the multi path may be well managed under a DC scenario.

### Specific Embodiments

Merely for better understanding, some specific embodiments will be described as below. It should be understood that below specific embodiments should not be considered as any limitation to the present disclosures.

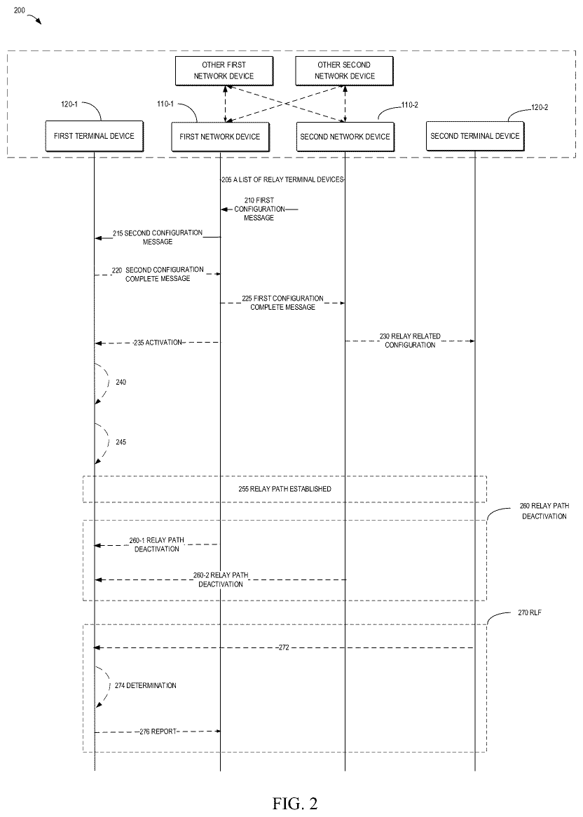

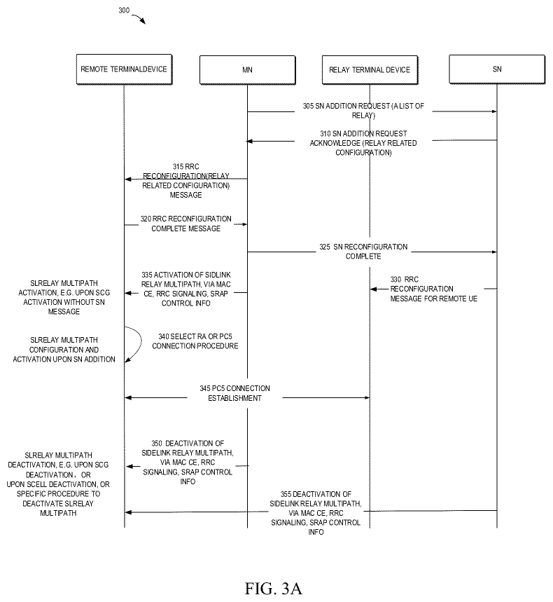

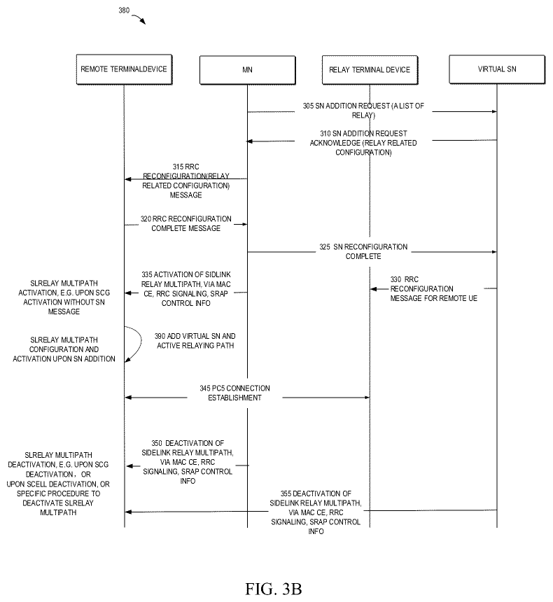

Reference is now made to FIG. 3A, which a signaling chart illustrating a process 300 of communication according to some example embodiments of the present disclosure. The process 300 may involve the remote terminal device (such as, the first terminal device 120-1 as shown in FIG. 1A), an MN (such as, the first network device 110-1 as shown in FIG. 1A), an SN (such as, the second network device 110-2 as shown in FIG. 1A) and a relay terminal device (such as, the second terminal device 120-2 as shown in FIG. 1A).

In operation, the MN transmits 305 an SN Addition Request (including a list of relay terminal device) to the SN. The SN transmits 310 an SN Addition Request Acknowledge (including a relay related configuration) to the MN.

Next, the MN transmits 315 an RRC reconfiguration (including the relay related configuration) message to the remote terminal device. The remote terminal device may transmit 320 an RRC reconfiguration complete message to the MN.

In response to the RRC reconfiguration complete message, the MN may transmit 325 an SN Reconfiguration Complete to the SN.

As for the SN, the SN may transmit 330 an RRC reconfiguration message for Remote UE to configure the relaying path for the relay terminal device.

In some embodiments, the relaying path at the remote terminal device may be activated by a separate signaling. As shown in FIG. 3A, the relaying path at the remote terminal device is activated 335 via MAC CE, RRC signaling, SRAP control information, DCI or Sidelink Control Information (SCI).

The remote terminal device selects 340 either RA or PC5 connection procedure. Then, if PC5 connection procedure is selected, a PC5 connection is established 345.

Further, a deactivation procedure for the relaying path may be either initiated by the MN or the SN. As illustrated in FIG. 3A, the MN may deactivate 350 the sidelink relay multipath, via MAC CE, RRC signaling, SRAP control information, Downlink Control Information (DCI). Alternatively, the SN also may deactivate 355 the sidelink relay multipath, via MAC CE, RRC signaling, SRAP control information, DCI. Alternatively, or in addition, the SN also may request the MN to deactivate 350 the sidelink relay multipath. For example, if the remote terminal device is not configured with SRB3, and if the SN determines to deactivate the sidelink relay multipath, the SN may request the MN to deactivate 350 the sidelink relay multipath, by sending an indication to the MN.

In some embodiments, if a relaying path is configured and activated (e.g. together with SN activation) by the network (e.g. the MN) with the message (e.g. RRCReconfiguration for SN/SCG addition), the remote terminal device may apply the relaying path configuration (e.g. relay related configuration). Additionally, the remote terminal device may perform an SCG addition or a virtual SCG addition as discussed above.

Additionally, the remote terminal device may performs/executes the sidelink relay multipath (or relay related configuration) activation procedure, including at least one of the following actions: Request the upper layer to initiate PC5 connection establishment with relay terminal device(s) configured by the message, indicated to the lower layers that the relaying path is activated or the SCG is activated with relaying path

In some embodiments, if the SCG activation is not configured with SN addition (e.g. scg-State is included) by the network (e.g. the MN), relaying path is not activated when it is configured too.

In some embodiments, the relaying path activation may be performed without SN message. Specifically, if the relaying path is activated (together with SCG activation) by the network (e.g. the MN) with the message (e.g. RRCReconfiguration for SCG activation without SN message), the remote UE performs relaying path activation procedure.

In some embodiments, one specific Scell may be activated via MAC CE. Specifically, if the relaying path is activated (e.g. together with Scell activation) by the network (e.g. the MN) with the message (e.g. MAC CE), the remote UE performs the relaying path activation procedure.

Alternatively, in some embodiments, the relaying path may be activated independently from the activation of the SCG or the Scell, such as, by indicating the relaying path ID via RRC massage/MAC CE during a separate procedure.

In some embodiments, if the SCG is deactivated by the network (e.g. the MN) with a message (e.g. an RRC message), the relaying path corresponding to the SCG is deactivated too. In other word, the relaying path

Alternatively, in some embodiments, if the Scell is deactivated by the network (e.g. the MN) with a message (e.g. RRC message), the relaying path corresponding to the Scell or the associatedSCG of the Scell is deactivated too.

Alternatively, in some embodiments, the relaying path may be deactivated independently from the SCG, such as, by indicating the relaying path id via RRC massage/MAC CE during a specific procedure.

In some embodiments, if relaying path is deactivated by the network (e.g. the MN), the remote terminal device performs relaying path deactivation procedure, including at least one of the following actions: performing sidelink specific MAC reset (at MAC layer), and without transmitting SL-SCH/PSSCH (Physical Sidelink Shared Channel) on the PC5 connection corresponding to the deactivated SN/deactivated SCell/deactivated path (at MAC layer). In this way, PC5 connection is kept.

In some embodiments, if relaying path is deactivated by the network (e.g. the MN), the remote terminal device performs relaying path deactivation procedure, including at least one of the following actions: indicate the upper layer (of RRC) to release the PC5 connection corresponding to the indicated relaying path (at RRC layer). Alternatively, or in addition, the remote terminal device performs relaying path deactivation procedure, including at least one of the following operations: release the PC5 connection locally, or indicated to the upper layer (of RRC) that the PC5 connection has been released. In this way, PC5 connection is released.

In some embodiments, the remote terminal device performs the activation of relaying path and SCG simultaneously.

In some embodiments, the activation of relaying path and SCG simultaneously is stipulated as a default operation. Alternatively, the activation of relaying path and SCG simultaneously needs an explicit indication. In one specific embodiment, the activation of relaying path and SCG simultaneously (e.g. an activation indication) is indicated in the RRCReconfiguration message, for example, RelayingPath-Simultaneously is set to true, or is configured/included, or is not configured/included. In another specific embodiment, an activation indication indicates whether to active relaying path, e.g. RelayingPath-State is set to true, or is configured/included, or is not configured/included. Specifically, RelayingPath-Simultaneously being set to true means that active relaying path and SCG simultaneously. RelayingPath-Simultaneously (ENUMERATED {activated}) being included in the RRC message means that active relaying path and SCG simultaneously. RelayingPath-Simultaneously (ENUMERATED {deactivated}) being include in the RRC message means that do not active relaying path and SCG simultaneously. Specifically, RelayingPath-State being set to true means that active relaying path. RelayingPath-State (ENUMERATED {activated}) being included in the RRC message means that active relaying path. RelayingPath-State (ENUMERATED {deactivated}) being include in the RRC message means that do not active relaying path.

### Examples of SN Addition Including Relaying Path Addition

These specific examples will be discussed with reference to FIG. 3A.

In some embodiments, the MN decides to request the SN to allocate resources for one or more specific PDU sessions/QoS flows. Further, the QoS Flows characteristics (QoS Flow Level QoS parameters, PDU session level TNL address information, and PDU session level Network Slice info) may be indicated. The MN also provides 305 a list of relay terminal devices and/or the latest measurement results about Relay terminal devices for the SN to choose and configure the relay terminal device for one or multiple SCG cells.

In some embodiments, the SN decides for the PSCell and other SCG SCells and Relay terminal device and provides 310 the new SCG radio resource configuration and relaying path configuration to the MN within an SN RRC configuration message contained in the SN addition request acknowledge message. Alternatively, relaying path configuration may be included in the new SCG radio resource configuration. The SN addition request acknowledge message indicates: relaying path configuration/relay related configuration: includes at least L2 U2N Relay UE ID, Remote UE's local ID, PC5 Relay RLC channel configuration for relay traffic and the associated end-to-end radio bearer(s). Additionally, the SN addition request acknowledge message also may indicate: ID of relaying path, or the ID of multipath relaying configuration.

The MN sends 315 the MN RRC reconfiguration message to the remote terminal device, where the MN RRC reconfiguration message includes the SN RRC configuration message, without modifying it. Within the MN RRC reconfiguration message, the MN can indicate the SCG is deactivated.

The remote terminal device applies the new configuration and replies 320 to MN with MN RRC reconfiguration complete message, including an SN RRC response message for SN, if needed. In case that the UE is unable to comply with (part of) the configuration included in the MN RRC reconfiguration message, it performs the reconfiguration failure procedure.

In some embodiments, the MN informs 325 the SN that the remote terminal device has completed the reconfiguration procedure successfully via SN Reconfiguration Complete message, including the SN RRC response message, if received from the remote terminal device.

In some embodiments, if configured with bearers requiring SCG radio resources, the relaying path is not deactivated (e.g. the SCG is not deactivated), and the path related information, such as at least one relay terminal device, is indicated, the remote terminal device performs PC5 connection establishment with the relay terminal device(s) configured by the SN. Alternatively, or in addition, the remote terminal device loads relaying path configuration, such as applying the configuration of PC5 RLC relay channel for the relaying path.

Alternatively, in some embodiments, if configured with bearers requiring SCG radio resources, the relaying path is not deactivated (e.g. the SCG is not deactivated), the path related information is indicated and RelayingPath-Simultaneously is set to true (or is configured/included, or is not configured/included), the remote terminal device performs PC5 connection establishment with the relay terminal device(s) configured by the SN. Alternatively, in some embodiments, if configured with bearers requiring SCG radio resources, the SCG is not deactivated, the path related information is indicated and RelayingPath-State is set to true (or is configured/included, or is not configured/included), the remote terminal device performs PC5 connection establishment with the relay terminal device(s) configured by the SN.

Optionally, the order of the remote terminal device sending the MN RRC reconfiguration complete message and performing the PC5 connection establishment towards the Relay UE served by the SCG is not defined. Optionally, the successful PC5 connection establishment towards Relay UE served by the SCG is not required for a successful completion of the RRC Connection Reconfiguration procedure.

In some embodiments, (if the path related information is not indicated and) if configured with bearers requiring SCG radio resources and the SCG is not deactivated, the remote terminal device performs synchronization towards the PSCell configured by the SN.

Further, the order of the UE sending the MN RRC reconfiguration complete message and performing the random access procedure towards the SCG is not defined. Further, the successful random access procedure towards the SCG is not required for a successful completion of the RRC Connection Reconfiguration procedure.

In some embodiments, the path related information (such as, at least one relay terminal device) is indicated in IE mrdc-SecondaryCellGroupConfig. The path related information may be included in the relaying path configuration.

Alternatively, in some embodiments, the path related information is indicated in CellGroupConfig. Further, the serving cell of Relay UE is indicated.

Alternatively, in some embodiments, the path related information is indicated in spCellConfig of CellGroupConfig, which means the relay is served by spCell.

Further, the path related information (such as, at least one relay terminal device) is relay terminal device ID, for example, layer2 source ID, 24bits.

Alternatively, in some embodiments, the path related information is defined as a new field/IE (e.g. sl-RelayingPathConfig) for sidelink multipath configuration, and the new field/IE may include at least one of the following:
At least one Relay UE ID.
Optionally, the relaying path ID, or the ID of multipath relaying configuration, or
Optionally, indication to set this path as primary path or secondary path.

Alternatively, in some embodiments, the path related information includes a new variable (e.g. SLRelayMultipath) and it is set to true to indicate the configuration of relaying path. Additionally, a relay terminal device ID for multipath is indicated too. Additionally, multiple relaying paths may be configured.

In some embodiments, the SN sends an RRCReconfiguration message to the selected (L2 U2N) relay terminal device for relaying path, which at least includes L2 U2N remote terminal device's local ID and L2 ID, Uu and PC5 Relay RLC channel configuration for relaying, and bearer mapping configuration. It may also indicate the relaying path ID.

Optionally, in some embodiments, the SN may indicate whether the configuration of relaying path for Remote UE is to be activated, or the SN may send this message to the relay terminal device only when SCG activation is configured (which means relaying path is activated too) with SN addition. Alternatively, or in addition, the SN may send this message to the relay terminal device only when the SN or MN determine to active the SCG or the relaying path.

One example of part of the IE mrdc-SecondaryCellGroup (where mrdc-SecondaryCellGroup does not include configuration for SN/SCG except relay related configuration) is illustrated as below.

Mrdc-SecondaryCellGroup
• sl-RelayingPathConfig

[symbol]

[symbol]

[symbol]

[symbol]

[symbol]

[symbol]

• secondaryCellGroup, (CellGroupConfig),
▪ sl-RelayingPathConfig,

[symbol]

[symbol]

[symbol]

[symbol]

[symbol]

[symbol]

[symbol]

[symbol]

[symbol]

The strikethrough marked in the above example means that the corresponding contents are not included anymore/omitted/deleted.

Another example of part of the IE mrdc-SecondaryCellGroup (where mrdc-SecondaryCellGroup does not include configuration for SN/SCG except relay related configuration) is illustrated as below. For example, the CellGroupConfig for the SCG dose not include the configuration of RLC layer and MAC layer for itself.

In some embodiments, during an SN addition, the remote terminal device activates the relaying path based on sl-RelayingPathConfig, specifically,
if the scg-State is not included in the RRCReconfiguration or RRCResume message containing the RRCReconfiguration message:
   if the SCG was deactivated before the reception of the NR RRC message containing the RRCReconfiguration message:
      perform SCG activation;
   if reconfiguration WithSync was included in spCellConfig in nr-SCG:
      initiate the random access procedure on the PSCell;
   else if the SCG was deactivated before the reception of the NR RRC message containing the RRCReconfiguration message:
      if sl-RelayingPathConfig is included (e.g. sl-RelayingPathConfig is included and RelayingPath-Simultaneously is set to true),
         (optionally) consider the L2 U2N Relay UE for multipath to be the one indicated by the RelayUE-Identity in the sl-RelayingPathConfig;
         indicate to upper layer (to trigger the PC5 unicast link establishment) with the L2 U2N Relay UE indicated by the RelayUE-Identity for corresponding cell group/Pscell/Cell.
      else if bfd-and-RLM was not configured to true before the reception of the RRCReconfiguration or RRCResume message containing the RRCReconfiguration message; or
      if lower layers indicate that a random access procedure is needed for SCG activation:
         initiate the random access procedure on the PSCell;
      else:
         the procedure ends;

In some embodiments, the RRC layer of the remote terminal device performs relaying path related operations, at least comprising one of the following, indicating SCG is configured/activated with relaying path to lower layers (e.g. Uu MAC); without performing BFD and RLM; requesting the upper layer (of RRC) to establish the PC5 connection to relay UE corresponding to the relaying path.

In some embodiments, the MAC layer of the remote terminal device performs relaying path related actions, such as, transmit PSSCH/SL-SCH on the PC5-RRC connection (corresponding to the relaying path); initialize SBj for each logical channel associated to the PC5-RRC connection to zero.

In some embodiments, the MAC entity shall for the configured SCG:
1> if upper layers indicate that SCG is activated with relaying path:
   2> perform above mentioned relaying path related actions;
1> else if upper layers indicate that SCG is activated:
   2> if BFI COUNTER >=beamFailureInstanceMaxCount for the PSCell or the timeAlignmentTimer associated with PTAG is not running:
      3>indicate to upper layers that a random access Procedure (as specified in clause 5.1.1) is needed for SCG activation.
   2> else:
      3>activate the SCG according to the timing for direct SCG activation.
   2>pre-stipulated procedures.

In some embodiments, if the remote terminal device is configured with an SCG after receiving the message, the remote terminal device performs:
if the remote terminal device was configured with a deactivated SCG before receiving the message for which this procedure is initiated:
   consider the SCG to be activated;
   if sl-RelayingPathConfig is included/configured
      indicate to lower layers that the SCG is activated with relaying path (also Relay UE/sidelink relay multipath.)
   else (sl-RelayingPathConfig is not included)
      resume performing radio link monitoring on the SCG, if previously stopped;
      indicate to lower layers to resume beam failure detection on the PSCell, if previously stopped;
      indicate to lower layers that the SCG is activated.

Additionally, in some embodiments, the serving cell of relay terminal device may be indicated to lower layers.

In some embodiments, if the remote terminal device is configured with an SCG after receiving the message for which this procedure is initiated, the remote terminal device performs:
if the UE was configured with a deactivated SCG before receiving the message for which this procedure is initiated:
   consider the SCG to be activated;
   if sl-RelayingPathConfig is not included
      resume performing radio link monitoring on the SCG, if previously stopped;
      indicate to lower layers to resume beam failure detection on the PSCell, if previously stopped;
      indicate to lower layers that the SCG is activated without relaying path.
   else (if sl-RelayingPathConfig is included)
      indicate to lower layers that the SCG is activated with relaying path.

Additionally, in some embodiments, the serving cell of relay terminal device may be indicated to lower layers.

In some embodiments, the MAC entity shall for the configured SCG:
1> if upper layers indicate that SCG is activated without relaying path:
   2> if BFI COUNTER >=beamFailureInstanceMaxCount for the PSCell or the timeAlignmentTimer associated with PTAG is not running:
      3>indicate to upper layers that a random access Procedure is needed for SCG activation.
   2> else:
      3>activate the SCG according to the timing for direct SCG activation.
   2>pre-stipulated procedures.
1> else if upper layers indicate that SCG is activated with relaying path:
   2> perform relaying path related actions;

### Examples of SCG Activation without SN Message

In some embodiments, the RRC layer of the remote terminal device performs relaying path related operations, including at least one of the following, indicating SCG is configured/activated with relaying path to lower layers (e.g. Uu MAC); without performing BFD and RLM; requesting the upper layer (of RRC) to establish the PC5 connection to relay UE corresponding to the relaying path.

In some embodiments, the MAC layer of the remote terminal device performs relaying path related actions, such as, transmit PSSCH/SL-SCH on the PC5-RRC connection (corresponding to the relaying path); initialize SBj for each logical channel associated to the PC5-RRC connection to zero.

In some embodiments, the remote terminal device triggers SCG activation without SN message. Specifically,
1> if RRCReconfiguration was received via SRB1):
   2> if the UE is in NR-DC and;
   2> if the RRCReconfiguration does not include the mrdc-SecondaryCellGroupConfig:
      3> if the RRCReconfiguration includes the scg-State:
         4> perform SCG deactivation;
      3> else:
         4> perform SCG activation without SN message;—not include scg-State
   2>submit the RRCReconfigurationComplete message via SRB1 to lower layers for transmission using the new configuration;
   2> if this is the first RRCReconfiguration message after successful completion of the RRC re-establishment procedure:
      3>resume SRB2, SRB4, DRBs, multicast MRB, and BH RLC channels for IAB-MT, that are suspended;

In some embodiments, if the SCG was deactivated before the reception of the RRCReconfiguration message or the E-UTRA RRCConnectionReconfiguration message for which the procedure invoking this clause is executed:
consider the SCG to be activated;
If SCG is configured with relaying path:
   indicate to lower layers that the SCG is activated with relaying path;
else
   indicate to lower layers that the SCG is activated;
   pre-stipulated procedures.

Additionally, the remote terminal device performs the SCG activation as discussed with regards to the examples of SN addition including relaying path addition. Merely for brevity, same contents are omitted here.

### Examples of SCG Deactivation

The remote terminal device performs SCG deactivation and manages PC5 connection. In some embodiments, the remote terminal device releases the PC5-RRC connection for the relaying path corresponding to the SCG. In one specific embodiment, the PC5-RRC is released and indicated it to the upper layer. Alternatively, in another specific embodiment, the remote terminal device triggers the upper layer to release the configuration.

In some embodiments, the remote terminal device suspends the PC5-RRC connection for the relaying path corresponding to the SCG. In one specific embodiment, the remote terminal device suspends the transmission via the PC5 connection. The MAC layer of the remote terminal device performs sidelink specific MAC reset while does not transmit PSSCH/SL-SCH on the PC5-RRC connection corresponding to the relaying path and does not perform measurement or monitoring of sidelink, such as receiving and transmission of discovery message.

Additionally, in some embodiments, the receiving and transmission of discovery message (also be referred to as the measurement of sidelink) of the remote terminal device is controlled by the first network device or the second network device with separate indicator, such as SL-Discovery. For example, if the SL-Discovery is set to true, the remote terminal device performs the receiving and transmission of discovery message on this PC5-RRC connection.

In summary, a separate indicator used for discovery message enables the PC5 link monitoring during suspension.

In some embodiments, the remote terminal device triggers SCG deactivation as below,
1> if RRCReconfiguration was received via SRB1:
   2> if the UE is in NR-DC and;
   2> if the RRCReconfiguration does not include the mrdc-SecondaryCellGroupConfig:
      3> if the RRCReconfiguration includes the scg-State:
         4> perform SCG deactivation;
      3> else:
         4> perform SCG activation without SN message
   2>submit the RRCReconfigurationComplete message via SRB1 to lower layers for transmission using the new configuration;
   2> if this is the first RRCReconfiguration message after successful completion of the RRC re-establishment procedure:
      3>resume SRB2, SRB4, DRBs, multicast MRB, and BH RLC channels for IAB-MT, that are suspended.

In some embodiments, the remote terminal device triggers SCG deactivation as below,
1> consider the SCG to be deactivated;
1> if the SCG is configured with relaying path/SCG is deactivated with relaying path
   Alt1.1 2> consider the PC5-RRC connection to be released and indicated it to the upper layer (of RRC)
   Alt1.2 2>send relay UE ID of the relaying path to trigger the upper layer to release the PC5-RRC connection corresponding to the relying path
1> else
   2>indicate to lower layers that the SCG is deactivated;
   2> if bfd-and-RLM is configured to true:
      3> perform radio link monitoring on the SCG;
      3>pre-stipulated procedures.

In some embodiments, upon initiating the procedure, the remote terminal device triggers SCG deactivation as below,
1> consider the SCG to be deactivated;
1> if the SCG is deactivated with relaying path
   2>indicate to lower layers that the SCG is deactivated with relaying path;
1> else
   2>indicate to lower layers that the SCG is deactivated;
   2> if bfd-and-RLM is configured to true:
      3> perform radio link monitoring on the SCG;
      3>pre-stipulated procedure.

In some embodiments, the remote terminal device triggers SCG deactivation as below,
1> if upper layers indicate that SCG is activated:
1> else if upper layers indicate that the SCG is deactivated:
   2>pre-stipulated procedures
1> else if upper layers indicate that the SCG is deactivated with relaying path:
   2>deactivate all the SCells of the SCG;
   2>deactivate SCG according to the timing;
   2>clear any configured downlink assignment and any configured uplink grant Type 2 associated with the PSCell respectively;
   2>suspend any configured uplink grant Type 1 associated with the PSCell;
   2> perform Sidelink specific MAC reset.
1> if the SCG is deactivated with relaying path:
   2>Not transmit SL-SCH on the PC5-RRC connection identified by the Relay UE ID (destination indicated by the upper layer) or the pair of Remote UE ID (source layer 2 ID) and Relay UE ID, and the PC5-RRC connection is corresponding to the relaying path
1> else if the SCG is deactivated:
   2>pre-stipulated procedures.

As discussed above, in some embodiments, the first network device 110-1 and the second network device 110-2 may share some hardware resource. In this event, one of the first network device 110-1 and the second network device 110-2 may be considered as a virtual network device. FIG. 3B illustrates a signaling chart illustrating a process 380 of communication according to some example embodiments of the present disclosure. As can be seen by comparing FIG. 3A with FIG. 3B, the main difference is that in case that SN is virtual SN, the RA procedure is unnecessary. Specifically, as illustrated in FIG. 3B, after determining to activate the relaying path, the remote terminal device adds 390 virtual SN and activates the relaying path.

Further, the virtual SN (also be referred to as virtual SCG, a virtual SN/SCG) may be indicated either explicitly or implicitly.

In some embodiments, the mrdc-SecondaryCellGroupConfig set to virtualsetup (for example, ENUMER {setup, virtualsetup}, which means a virtual SN is applied.

Alternatively, in some embodiments, a new indicator (for example, indicator #1) for virtual addition may be introduced for indicating virtual SN.

In some embodiments, the RRC message for SN only includes the relay related configuration, and does not include secondaryCellGroup, otherConfig, conditionalReconfiguration, measConfig, bap-Config and IAB-IP-AddressConfigurationList. In this way, the virtual SN may be indicated implicitly.

One example of IE mrdc-SecondaryCellGroup is illustrated as below:
Mrdc-SecondaryCellGroup
   sl-RelayingPathConfig.

Alternatively, in some embodiments, the RRC message for SN only includes secondaryCellGroup including the relay related configuration. In this way, the virtual SN may be indicated implicitly. One example of IE secondaryCellGroup is illustrated as below:
Mrdc-SecondaryCellGroup
   secondaryCellGroup,
      sl-RelayingPathConfig.

Alternatively, in some embodiments, the virtual SN may be indicated if the SpCell of MN is indicated to as the Specell of SN. Therefore, the SpCell of MN is set to as the SpCell of SN/SCG. In this way, the virtual SN may be indicated implicitly.

Alternatively, in some embodiments, the virtual SN may be indicated if the Cell group ID of SN is configured the same with that of MN. In this way, the virtual SN may be indicated implicitly.

Alternatively, in some embodiments, the virtual SN may be indicated if at least one cell of the MCG is configured the same with the cell of SCG. In this way, the virtual SN may be indicated implicitly.

Additionally, in some embodiments, when perform RRC reconfiguration, only the relay related configuration in secondaryCellGroup or in mrdc-SecondaryCellGroup or corresponding to SN is applied. In other words, the virtual SN may reuse the cell group configuration of the MN, or the MN can be reused as the virtual SN, or the MN and the virtual SN can be managed as one node, or the MCG can be reused as the SCG, or the Spcell of MCG/MN can be reused as that of SCG, or at least one cell of MCG is reused as the cell of SCG. Alternatively, or in addition, in some embodiments, the relay related configuration or indication is included in the RRC message for SN (such as, nr-SCG), or not in this message.

Additionally, when perform RRC reconfiguration for virtual SN, only the relay related configuration is applied.

In one specific example embodiment, when adding virtual SN, the remote terminal device performs as below:
1> if the RRCReconfiguration includes the secondaryCellGroup:
   2> perform the cell group configuration for the SCG;
1> if the RRCReconfiguration includes the mrdc-SecondaryCellGroupConfig:
   2> if the mrdc-SecondaryCellGroupConfig is set to setup:
      3> if the mrdc-SecondaryCellGroupConfig includes mrdc-ReleaseAndAdd:
         4> perform MR-DC release;
      3> if the received mrdc-SecondaryCellGroup is set to nr-SCG-—for NR DC
         4> perform the RRC reconfiguration for the RRCReconfiguration message included in nr-SCG;
      3> if the received mrdc-SecondaryCellGroup is set to eutra-SCG:
         4> perform the RRC connection reconfiguration for the RRCConnectionReconfiguration message included in eutra-SCG;
   2> if the mrdc-SecondaryCellGroupConfig is set to virtualsetup:
      3>the relay related configuration in secondaryCellGroup/the relay related configuration corresponding to SN is applied, including PC5 connection establishment.
   2> else (mrdc-SecondaryCellGroupConfig is set to release):
      3> perform MR-DC release.

The other operations in FIG. 3B are similar with those in FIG. 3A. For brevity, similar contents are omitted here.

In the following, example processes (such as SN modification and SN/MN handover) are discussed. Although below examples are discussed with regards to normal SN, it is to be understood that such example processes also be adaptable for the scenario of virtual SN based on the teaching of the discussion on FIG. 3A and FIG. 3B. For brevity, similar contents are omitted here.

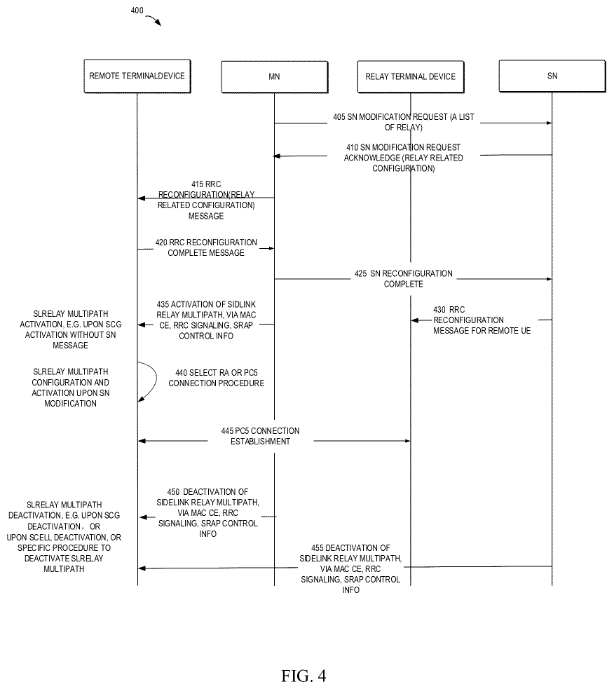

Now Reference is now made to FIG. 4, which a signaling chart illustrating a process 400 of communication according to some example embodiments of the present disclosure. The process 400 may involve the remote terminal device (such as, the first terminal device 120-1 as shown in FIG. 1A), an MN (such as, the first network device 110-1 as shown in FIG. 1A), an SN (such as, the second network device 110-2 as shown in FIG. 1A) and a relay terminal device (such as, the second terminal device 120-2 as shown in FIG. 1A).

In operation, the MN transmits 405 an SN modification Request (including a list of relay terminal device) to the SN. The SN transmits 410 an SN modification request acknowledge (including a relay related configuration) to the MN.

Next, the MN transmits 415 an RRC reconfiguration (including the relay related configuration) message to the remote terminal device. The remote terminal device may transmit 420 an RRC reconfiguration complete message to the MN.

In response to the RRC reconfiguration complete message, the MN may transmit 425 an SN Reconfiguration Complete to the SN.

As for the SN, the SN may transmit 430 an RRC reconfiguration message for Remote UE to configure the relaying path for the relay terminal device. In some embodiments, the relaying path at the remote terminal device may be activated by a separate signaling. As shown in FIG. 4, the relaying path at the remote terminal device is activated 435 via MAC CE, RRC signaling, SRAP control information.

The remote terminal device selects 440 either RA or PC5 connection procedure. Then, a PC5 connection is established 445.

Further, a deactivation procedure for the relaying path may be either initiated by the MN or the SN. As illustrated in FIG. 4, the MN may deactivate 450 the sidelink relay multipath, via MAC CE, RRC signaling, SRAP control information. Alternatively, the SN also may deactivate 455 the sidelink relay multipath, via MAC CE, RRC signaling, SRAP control information.

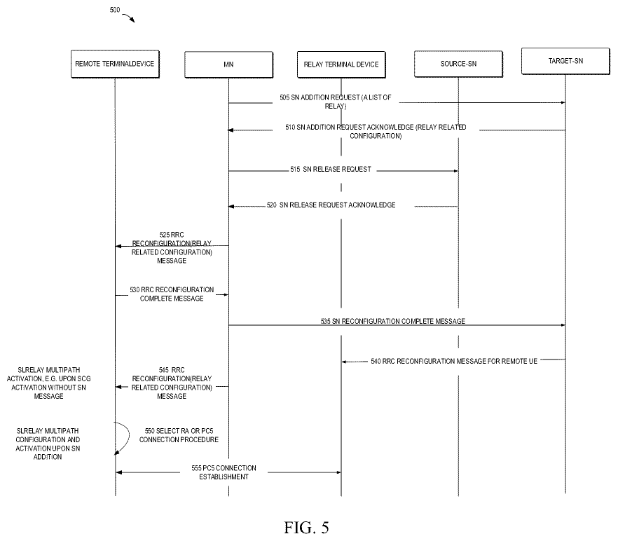

Now Reference is now made to FIG. 5, which a signaling chart illustrating a process 500 of communication according to some example embodiments of the present disclosure. The process 500 may involve the remote terminal device (such as, the first terminal device 120-1 as shown in FIG. 1A), an MN (such as, the first network device 110-1 as shown in FIG. 1A), a target SN (such as, the second network device 110-2 as shown in FIG. 1A), a source SN and a relay terminal device (such as, the second terminal device 120-2 as shown in FIG. 1A).

In operation, the MN transmits 505 an SN addition request (including a list of relay terminal device) to the target SN. The target SN transmits 510 an SN addition request acknowledge (including a relay related configuration) to the MN.

The MN transmits 525 an SN Release Request to the source SN and receives 520 an SN Release Request Acknowledge form the source SN,

Next, the MN transmits 525 an RRC reconfiguration (including the relay related configuration) message to the remote terminal device. The remote terminal device may transmit 530 an RRC reconfiguration complete message to the MN.

In response to the RRC reconfiguration complete message, the MN may transmit 535 an SN Reconfiguration Complete to the target SN.

As for the target SN, the target SN may transmit 540 an RRC reconfiguration message for Remote UE to configure the relaying path for the relay terminal device.

In some embodiments, the relaying path at the remote terminal device may be activated by a separate signaling. As shown in FIG. 5, the relaying path at the remote terminal device is activated 545 via MAC CE, RRC signaling, SRAP control information.

The remote terminal device selects 550 either RA or PC5 connection procedure. Then, a PC5 connection is established 555.

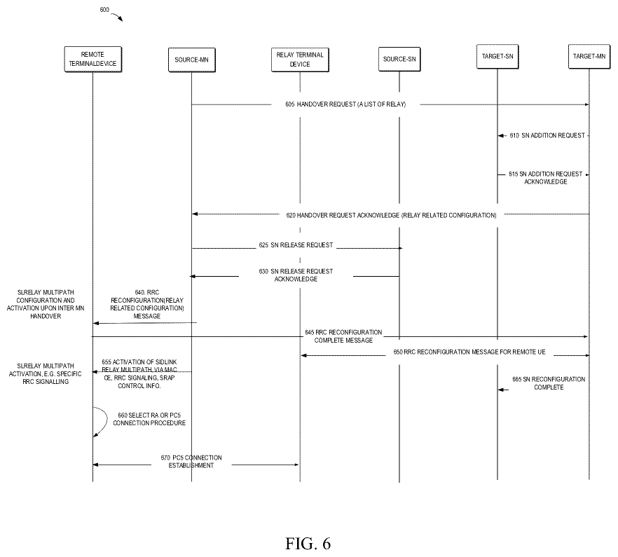

Now Reference is now made to FIG. 6, which a signaling chart illustrating a process 400 of communication according to some example embodiments of the present disclosure. The process 400 may involve the remote terminal device (such as, the first terminal device 120-1 as shown in FIG. 1A), a source MN, a target MN, a source SN, a target SN and a relay terminal device (such as, the second terminal device 120-2 as shown in FIG. 1A).

In operation, the source MN transmits 605 a handover request (a list of relay terminal device) to the target MN. Then the target MN transmits 610 an SN addition request to the target SN. The target SN transmits 615 an SN addition request acknowledge (including a relay related configuration) to the target MN. Next, the target MN transmits 620 a handover request acknowledge (relay related configuration).

The source MN transmits 625 an SN Release Request to the source SN and receives 630 an SN Release Request Acknowledge form the source SN.

The source MN transmits 640 an RRC reconfiguration (including the relay related configuration) message to the remote terminal device.

The remote terminal device transmits 645 an RRC reconfiguration complete message to the target MN and the target MN transmit 665 SN Reconfiguration Complete to the target SN.

As for the target MN, the target MN may transmit 650 an RRC reconfiguration message for Remote UE to configure the relaying path for the relay terminal device.

In some embodiments, the relaying path at the remote terminal device may be activated by a separate signaling. As shown in FIG. 6, the relaying path at the remote terminal device is activated 655 via MAC CE, RRC signaling, SRAP control information.

The remote terminal device selects 660 either RA or PC5 connection procedure. Then, a PC5 connection is established 670.

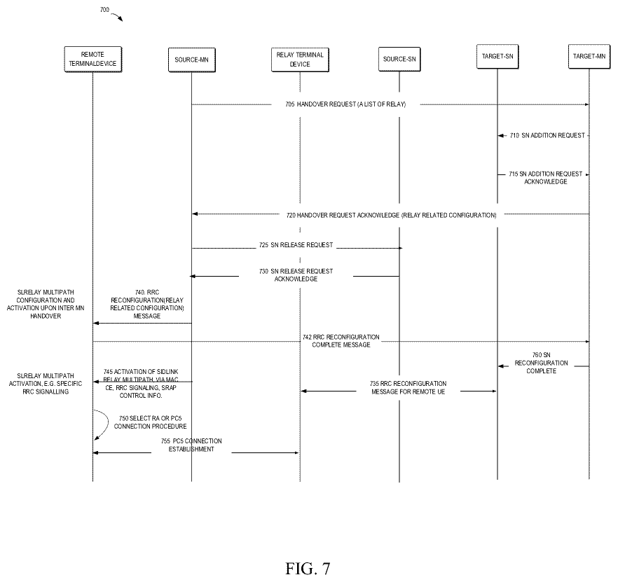

Now Reference is now made to FIG. 7, which a signaling chart illustrating a process 700 of communication according to some example embodiments of the present disclosure. The process 700 may involve the remote terminal device (such as, the first terminal device 120-1 as shown in FIG. 1A), a source MN, a target MN, a source SN, a target SN and a relay terminal device (such as, the second terminal device 120-2 as shown in FIG. 1A).

In operation, the source MN transmits 705 a handover Request (a list of Relay) to the target MN. Then the target MN transmits 710 an SN addition request to the target SN.

The target SN transmits 715 an SN addition request acknowledge (including a relay related configuration) to the target MN. Next, the target MN transmits 720 a handover Request Acknowledge (Relay related configuration).

The source MN transmits 725 an SN Release Request to the source SN and receives 730 an SN Release Request Acknowledge form the source SN.

The source MN transmits 740 an RRC reconfiguration (including the relay related configuration) message to the remote terminal device.

The remote terminal device transmits 742 an RRC reconfiguration complete message to the target MN and the target MN transmit 760 SN Reconfiguration Complete to the target SN.

As for the target SN, the target SN may transmit 735 an RRC reconfiguration message for Remote UE to configure the relaying path for the relay terminal device.

In some embodiments, the relaying path at the remote terminal device may be activated by a separate signaling. As shown in FIG. 7, the relaying path at the remote terminal device is activated 745 via MAC CE, RRC signaling, SRAP control information.

The remote terminal device selects 750 either RA or PC5 connection procedure. Then, a PC5 connection is established 755.

### Examples of RLF Handling with Sidelink Relay Multipath

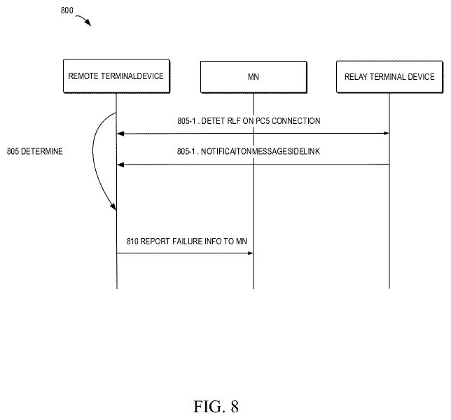

Examples of RLF handling will be discussed with reference to FIG. 8. In summary, an SCG RLF is detected based on RLF of relaying path and report the SCG RLF information via the MN path. Further, an RLF cause may be used to indicate the specific reason of SCG failure.

RLF failure may be determined 805 either by detecting 805-1 the PC5 connection or receiving 805-2 notification message from the relay terminal device.

In the present discourse, a failure, e.g. radio link failure for the SCG, may be detected 805-1. In some embodiments, if it is indicated by the upper layer (or RRC) that the failure of PC5 connection establishment corresponding to the SCG (e.g. SCG activation)/SN (e.g. SN addition), it is determined that a relaying path failure is detected. Alternatively, in some embodiments, after N times of retry of PC5 connection establishment corresponding to the SCG/SN, it is determined that a relaying path failure is detected.

In some embodiments, if MCG transmission is not suspended, the remote terminal device may initiate the SCG failure information procedure to report 810 the failure information to MN.

In some embodiments, the field (such as, rlf-Caus) is set to PC5-EstablishFailure to indicate the failure of PC5 connection establishment. Additionally, one of more of the terminal device ID or ID of corresponding Scell (of SCG), or ID of the multipath relaying configuration may be included.

In some embodiments, the remote terminal device connects to MN via direct/indirect network connection and connect to SN via direct network connection, or connect to MN via indirect network connection and connect to SN via direct/indirect network connection. In these scenarios, the remote terminal device may report failure information to the MN upon detecting RLF on PC5 connection as discussed below.

In some embodiments, if RLF of PC5 unicast link is detected and if this PC5 unicast link is corresponding to the SCG/SN, a (SCG) failure is determined to be detected. Further, if MCG transmission is not suspended, initiate the SCG failure information procedure. In one specific example embodiment, the rlf-Cause is set with value “sl-rlf” to indicate the failure of PC5 connection. Alternatively, one specific example embodiment, the rlf-Cause is set with any of the following values to indicate the failure of PC5 connection:
T400 expiry-T400 expiry for a specific destination;
HARQ DTX Failure—the maximum number of consecutive HARQ DTX for a specific destination
integrity Check Failure-integrity check failure concerning SL-SRB2 or SL-SRB3 for a specific destination

Additionally, in some embodiments, at least one of the ID of relaying path, or the relay terminal device ID, the ID of corresponding Scell (of SCG), or the ID of the multipath relaying configuration is included in the failure information.

In some embodiments, the remote terminal device connects to MN via direct/indirect network connection and connect to SN via direct network connection, or connect to MN via indirect network connection and connect to SN via direct/indirect network connection. In these scenarios, the remote terminal device detects the relaying path failure upon receiving NotificaitonMessageSidelink message from the relay terminal device.

### Example of Methods

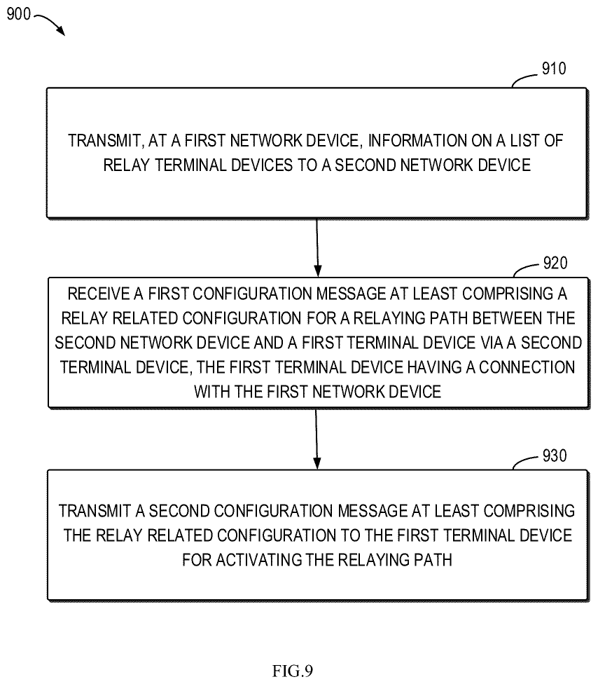

FIG. 9 illustrates a flowchart of an example method 900 in accordance with some embodiments of the present disclosure. For example, the method 900 can be implemented at the first network device 110-1 as shown in FIG. 1A.

At block 910, the first network device 110-1 transmits information on a list of relay terminal devices to a second network device 110-2.

At block 920, the first network device 110-1 receives a first configuration message at least comprising a relay related configuration for a relaying path between the second network device 110-2 and a first terminal device 120-1 via a second terminal device 120-2, the first terminal device 120-1 having a connection with the first network device 110-1; and

At block 930, the first network device 110-1 transmits a second configuration message at least comprising the relay related configuration to the first terminal device 120-1 for activating the relaying path.

In some embodiments, the first network device 110-1 comprises a MN, the second network device 110-2 comprises a SN. The first network device 110-1 transmits the information on the list of relay terminal devices in an SN addition request, and receives the first configuration message in an SN addition request acknowledgement message.

In some embodiments, the first network device 110-1 comprises a MN, the second network device 110-2 comprises a SN. The first network device 110-1 transmits the information on the list of relay terminal devices in an SN modification request, and receives the first configuration message in an SN modification request acknowledgement message.

In some embodiments, the first network device 110-1 comprises a source MN, the second network device 110-2 comprises a target MN. The first network device 110-1 transmits the information on the list of relay terminal devices in a handover request, and receives the first configuration message in a handover request acknowledgement message.

In some embodiments, the first network device 110-1 comprises a source MN, the second network device 110-2 comprises a target SN which is to be changed from a source SN. The first network device 110-1 transmits to a target MN the information on the list of relay terminal devices in a handover request, the information on the list of relay terminal devices being transmitted from the target MN to the target SN in an SN addition request. The first network device 110-1 receives, from the target MN, the first configuration message in a handover request acknowledgement message, the first configuration message being received at the target MN from the target SN in an SN addition request acknowledgement message.

In some embodiments, the relay related configuration comprises at least one of the following: an identification of the second terminal device 120-2, a local identification of the first terminal device 120-1, PC5 Relay RLC channel configuration for relay traffic, an associated end-to-end radio bearer, an identification of the relaying path, or an identification of multipath relaying configuration.

In some embodiments, the information on the list of relay terminal devices comprises at least one of the following: identifications of the list of relay terminal devices, or measurement results about the list of relay terminal devices.

In some embodiments, in response to receiving from the first terminal device 120-1 a second configuration complete message corresponding to the second configuration message, the first network device 110-1 transmits to the second network device 110-2 a first configuration complete message corresponding to the first configuration message.

In some embodiments, the first network device 110-1 comprises a MN and the second network device 110-2 comprises a SN, and both of the first and second configuration complete messages comprise SN RRC response message for the SN.

In some embodiments, the first configuration message further comprises a SCG radio resource configuration and the second configuration message further comprises the SCG radio resource configuration. The first network device 110-1 further determines whether a relaying path is deactivated based on the SCG radio resource configuration; and in accordance with a determination that the relaying path is deactivated, transmits to the first terminal device 120-1 an activation indication for activating the relaying path.

In some embodiments, the activation indication is transmitted via at least one of the following: a MAC CN, RRC signaling, or SRAP control information.

In some embodiments, the first network device 110-1 indicates lower layers that a SCG is activated with the relaying path.

In some embodiments, the first network device 110-1 transmits to the first terminal device 120-1 a deactivation indication for deactivating the relaying path.

In some embodiments, the first network device 110-1 receives, from the first terminal device 120-1, failure information associated with the relaying path.

In some embodiments, the failure information is about SCG RLF during configuration procedure of the relaying path.

In some embodiments, the SCG RLF is detected if: an upper layer indicates a failure of PC5 connection establishment corresponding to a SCG and/or a SN; or after N times of retry of PC5 connection establishment corresponding to the SCG and/or SN.

In some embodiments, the failure information comprises at least one of: a SCG RLF cause related to a failure of PC5 connection establishment, an identification of the second terminal device 120-2, an identification of corresponding Scell of SCG, an identification of the relaying path, or an identification of a multipath relaying configuration.

In some embodiments, the failure information is about detection of RLF on PC5 connection by the first terminal device 120-1.

In some embodiments, the RLF is detected if RLF of a PC5 unicast link is detected and if this PC5 unicast link is corresponding to the SCG and/or SN.

In some embodiments, the failure information comprises at least one of: a RLF cause related to a sidelink failure, T400 expiry for a predetermined destination, a maximum number of consecutive HARQ DRX for a predetermined destination, an integrity check failure concerning SL-signal radio bearer SRB2 or SL-SRB3 for a specific destination, an identification of the second terminal device 120-2, an identification of corresponding Scell of SCG, an identification of the relaying path, or an identification of a multipath relaying configuration.

In some embodiments, transmitting the failure information comprises: in response to receiving a NotificaitonMessageSidelink message from the second terminal device 120-2, transmitting the failure information.

In some embodiments, a RLF is detected by the first terminal device 120-1 if the NotificaitonMessageSidelink message is received from the second terminal device 120-2 and if a PC5 unicast link, identified by a source L2 identification of the second terminal device 120-2, is corresponding to the SCG and/or SN.

In some embodiments, the failure information comprises at least one of: a RLF cause related to a Uu failure, the second terminal device 120-2 detecting Uu RLF, the second terminal device 120-2 receiving an RRCReconfiguration including the reconfiguration WithSync, the second terminal device 120-2 performing cell reselection, the second terminal device 120-2's RRC connection failure including RRC connection reject, T300 expiry, an RRC resume failure, an identification of the second terminal device 120-2, an identification of corresponding Scell of SCG, an identification of the relaying path, or an identification of a multipath relaying configuration.

In some embodiments, the first network device 110-1 comprises a MN, the second network device 110-2 comprises a SN, and wherein the second configuration message further comprises a predetermined value or an indicator indicating a virtual SN.

In some embodiments, the first network device 110-1 comprises a MN, the second network device 110-2 comprises a SN, and wherein the second configuration message only comprises the relay related configuration, or the second configuration message indicates that a spCell of the MN is set as a spCell of the SN.

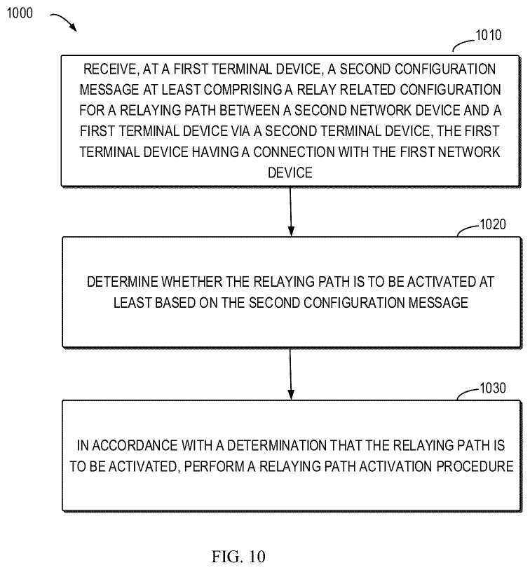

FIG. 10 illustrates a flowchart of an example method 1000 in accordance with some embodiments of the present disclosure. For example, the method 1100 can be implemented at the first terminal device 120-1 as shown in FIG. 1A.

At block 1010, the first terminal device 120-1 receives a second configuration message at least comprising a relay related configuration for a relaying path between a second network device 110-2 and a first terminal device 120-1 via a second terminal device 120-2, the first terminal device 120-1 having a connection with the first network device 110-1.

At block 1020, the first terminal device 120-1 determines whether the relaying path is to be activated at least based on the second configuration message.

At block 1030, the first terminal device 120-1 in accordance with a determination that the relaying path is to be activated, performs a relaying path activation procedure.

In some embodiments, the second configuration message further comprises an indication about whether the SCG is deactivated. The first terminal device 120-1 determines that the relaying path is to be activated if the indication indicates that the relaying path is not deactivated and path related information is indicated in the relay related configuration.

In some embodiments, the first terminal device 120-1 determines that the relaying path is to be activated in response to receiving, from the first network device 110-1, an activation indication for activating the relaying path.

In some embodiments, the activation indication is received via at least one of the following: a MAC CN, RRC signaling, or SRAP control information.

In some embodiments, the second configuration message is received via a RRC signaling.

In some embodiments, the first terminal device 120-1 transmits, to the first network device 110-1, a second configuration complete message corresponding to the second configuration message.

In some embodiments, the first terminal device 120-1 applies the relaying related configuration for data transmission; requests an upper layer to initiate PC5 connection establishment with the second terminal device 120-2; and indicates to a lower layer that the relaying path is activated or a SCG is activated with the relaying path.

In some embodiments, the first network device 110-1 comprises a MN, the second network device 110-2 comprises a SN, wherein the second configuration message further comprises a predetermined value or an indicator indicating a virtual SN. The first terminal device 120-1 uses configurations for the first network device 110-1 as configurations for the second network device 110-2.

In some embodiments, the first network device 110-1 comprises a MN, the second network device 110-2 comprises a SN, wherein the second configuration message only comprises the relay related configuration or the second configuration message indicates that a spCell of the MN is set as a spCell of the SN. The first terminal device 120-1 uses configurations for the first network device 110-1 as configurations for the second network device 110-2.

In some embodiments, the first terminal device 120-1 releases a PC5-RRC connection for the relaying path in response to receiving, from the first network device 110-1, a deactivation indication for deactivating a relaying path.

In some embodiments, the first terminal device 120-1 suspends a transmission via a PC5 connection of the relaying path and controls reception and transmission of a discovery message in response to receiving, from the first network device 110-1, a deactivation indication for deactivating a relaying path including a separate indicator for controlling the reception and transmission of a discovery message.

In some embodiments, the first terminal device 120-1 transmits, to the first network device 110-1, failure information associated with the relaying path.

In some embodiments, the failure information is about SCG RLF during configuration procedure of the relaying path.

In some embodiments, the SCG RLF is detected if: an upper layer indicates a failure of PC5 connection establishment corresponding to a SCG and/or a SN; or after N times of retry of PC5 connection establishment corresponding to the SCG and/or SN.

In some embodiments, the failure information comprises at least one of: a SCG RLF cause related to a failure of PC5 connection establishment, an identification of the second terminal device 120-2, an identification of corresponding Scell of SCG, an identification of the relaying path, or an identification of a multipath relaying configuration.

In some embodiments, the failure information is about detection of RLF on PC5 connection by the first terminal device 120-1.

In some embodiments, the RLF is detected if RLF of a PC5 unicast link is detected and if this PC5 unicast link is corresponding to the SCG and/or SN.

In some embodiments, the failure information comprises at least one of: a RLF cause related to a sidelink failure, T400 expiry for a predetermined destination, a maximum number of consecutive HARQ DTX for a predetermined destination, an integrity check failure concerning SL-SRB2 or SL-SRB3 for a specific destination, an identification of the second terminal device 120-2, an identification of corresponding Scell of SCG, an identification of the relaying path, or an identification of a multipath relaying configuration. In some embodiments, the first terminal device 120-1 transmits the failure information in response to receiving a NotificaitonMessageSidelink message from the second terminal device 120-2.

In some embodiments, a RLF is detected if the NotificaitonMessageSidelink message is received from the second terminal device 120-2 and if a PC5 unicast link, identified by a source L2 identification of the second terminal device 120-2, is corresponding to the SCG and/or SN.

In some embodiments, the failure information comprises at least one of: a RLF cause related to a Uu failure, the second terminal device 120-2 detecting Uu RLF, the second terminal device 120-2 receiving an RRCReconfiguration including the reconfiguration WithSync, the second terminal device 120-2 performing cell reselection, the second terminal device 120-2's RRC connection failure including RRC connection reject, T300 expiry, RRC resume failure, an identification of the second terminal device 120-2, an identification of corresponding Scell of SCG, an identification of the relaying path, or an identification of a multipath relaying configuration.

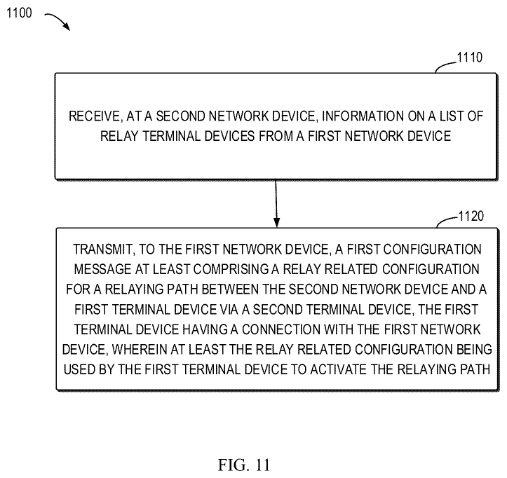

FIG. 11 illustrates a flowchart of an example method 1100 in accordance with some embodiments of the present disclosure. For example, the method 1000 can be implemented at the second network device 110-2 as shown in FIG. 1A.

At block 1110, the second network device 110-2 receives information on a list of relay terminal devices from a first network device 110-1.

At block 1120, the second network device 110-2 transmits, to the first network device 110-1, a first configuration message at least comprising a relay related configuration for a relaying path between the second network device 110-2 and a first terminal device 120-1 via a second terminal device 120-2, the first terminal device 120-1 having a connection with the first network device 110-1, wherein at least the relay related configuration being used by the first terminal device 120-1 to activate the relaying path.

In some embodiments, the second network device 110-2 transmits, to the second terminal device 120-2, a configuration message associated with the relaying path.

In some embodiments, the configuration message comprises at least one of: a local identification or an L2 identification of the second terminal device 120-2, an Uu and PC5 Relay RLC channel configuration for relaying, bearer mapping configuration, or an identification of the relaying path.

In some embodiments, the configuration message comprises an indication whether the configuration for the second terminal device 120-2 is to be activated.

In some embodiments, if SCG activation is configured with SN addition, the second network device 110-2 transmits the configuration message to the second terminal device 120-2.

In some embodiments, the first network device 110-1 comprises a MN, the second network device 110-2 comprises a SN. The second network device 110-2 receives the information on the list of relay terminal devices in an SN addition request, and transmits the first configuration message in an SN addition request acknowledgement message.

In some embodiments, the first network device 110-1 comprises a MN, the second network device 110-2 comprises a SN. The second network device 110-2 receives the information on the list of relay terminal devices in an SN modification request, and transmits the first configuration message in an SN modification request acknowledgement message.

In some embodiments, the first network device 110-1 comprises a source MN, the second network device 110-2 comprises a target MN. The second network device 110-2 receives the information on the list of relay terminal devices in a handover request, and transmits the first configuration message in a handover request acknowledgement message.

In some embodiments, the first network device 110-1 comprises a source MN, the second network device 110-2 comprises a target SN which is to be changed from a source SN.

The second network device 110-2 receives from a target MN, the information on the list of relay terminal devices in a handover request, the information on the list of relay terminal devices being transmitted from the target MN to the target SN in an SN addition request. The second network device 110-2 transmits, to the target MN, the first configuration message in a handover request acknowledgement message, the first configuration message being received at the target MN from the target SN in an SN addition request acknowledgement message.

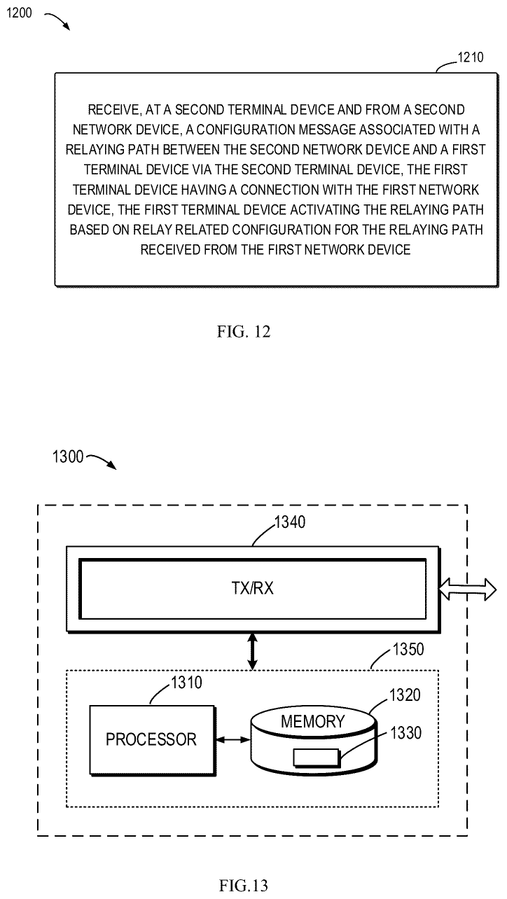

FIG. 12 illustrates a flowchart of an example method 1200 in accordance with some embodiments of the present disclosure. For example, the method 1200 can be implemented at the second terminal device 120-2 as shown in FIG. 1A.

At block 1210, the second terminal device 120-2 receives a configuration message associated with a relaying path between the second network device 110-2 and a first terminal device 120-1 via the second terminal device 120-2 from a second network device 110-2, the first terminal device 120-1 having a connection with the first network device 110-1, the first terminal device 120-1 activating the relaying path based on relay related configuration for the relaying path received from the first network device 110-1.

In some embodiments, the configuration message comprises at least one of: a local identification or an L2 identification of the second terminal device 120-2, an Uu and PC5 Relay RLC channel configuration for relaying, bearer mapping configuration, or an identification of the relaying path.

In some embodiments, the configuration message comprises an indication whether the configuration for the second terminal device 120-2 is to be activated.

In some embodiments, configuration of the relaying path of the second terminal device 120-2 is configured or activated after the first terminal device 120-1 activates the relaying path.

In some embodiments, a configuration of the relaying path of the second terminal device 120-2 is configured or activated upon the first terminal device 120-1 configures the relaying path.

### Example of Apparatuses and Devices

FIG. 13 is a simplified block diagram of a device 1300 that is suitable for implementing embodiments of the present disclosure. The device 1300 can be considered as a further example implementation of the terminal device 110 or the network device 120 as shown in FIG. 1. Accordingly, the device 1300 can be implemented at or as at least a part of the terminal device 110 or the network device 120.

As shown, the device 1300 includes a processor 1310, a memory 1320 coupled to the processor 1310, a suitable transmitter (TX)/receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones.

The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a first network device comprises a circuitry configured to: transmit information on a list of relay terminal devices to a second network device 110-2; receive a first configuration message at least comprising a relay related configuration for a relaying path between the second network device 110-2 and a first terminal device 120-1 via a second terminal device 120-2, the first terminal device 120-1 having a connection with the first network device 110-1; and transmit a second configuration message at least comprising the relay related configuration to the first terminal device 120-1 for activating the relaying path.

In some embodiments, the first network device 110-1 comprises a MN, the second network device 110-2 comprises a SN. The circuitry is further configured to: transmit the information on the list of relay terminal devices in an SN addition request, and receive the first configuration message in an SN addition request acknowledgement message.

In some embodiments, the first network device 110-1 comprises a MN, the second network device 110-2 comprises a SN. The circuitry is further configured to: transmit the information on the list of relay terminal devices in an SN modification request, and receive the first configuration message in an SN modification request acknowledgement message.

In some embodiments, the first network device 110-1 comprises a source MN, the second network device 110-2 comprises a target MN. The circuitry is further configured to: transmit the information on the list of relay terminal devices in a handover request, and receive the first configuration message in a handover request acknowledgement message.

In some embodiments, the first network device 110-1 comprises a source MN, the second network device 110-2 comprises a target SN which is to be changed from a source SN. The circuitry is further configured to: transmit to a target MN the information on the list of relay terminal devices in a handover request, the information on the list of relay terminal devices being transmitted from the target MN to the target SN in an SN addition request. The circuitry is further configured to: receive, from the target MN, the first configuration message in a handover request acknowledgement message, the first configuration message being received at the target MN from the target SN in an SN addition request acknowledgement message.

In some embodiments, the relay related configuration comprises at least one of the following: an identification of the second terminal device 120-2, a local identification of the first terminal device 120-1, PC5 Relay RLC channel configuration for relay traffic, an associated end-to-end radio bearer, an identification of the relaying path, or an identification of multipath relaying configuration.

In some embodiments, the information on the list of relay terminal devices comprises at least one of the following: identifications of the list of relay terminal devices, or measurement results about the list of relay terminal devices.

In some embodiments, The circuitry is further configured to: in response to receiving from the first terminal device 120-1 a second configuration complete message corresponding to the second configuration message, transmit to the second network device 110-2 a first configuration complete message corresponding to the first configuration message.

In some embodiments, the first network device 110-1 comprises a MN and the second network device 110-2 comprises a SN, and both of the first and second configuration complete messages comprise SN RRC response message for the SN.

In some embodiments, the first configuration message further comprises a SCG radio resource configuration and the second configuration message further comprises the SCG radio resource configuration. The circuitry is further configured to: determine whether a relaying path is deactivated based on the SCG radio resource configuration; and in accordance with a determination that the relaying path is deactivated, transmit to the first terminal device 120-1 an activation indication for activating the relaying path.

In some embodiments, the activation indication is transmitted via at least one of the following: a MAC CN, RRC signaling, or SRAP control information.

In some embodiments, The circuitry is further configured to: indicate lower layers that a SCG is activated with the relaying path.

In some embodiments, The circuitry is further configured to: transmit to the first terminal device 120-1 a deactivation indication for deactivating the relaying path.

In some embodiments, The circuitry is further configured to: receive, from the first terminal device 120-1, failure information associated with the relaying path.

In some embodiments, the failure information is about SCG RLF during configuration procedure of the relaying path.

In some embodiments, the SCG RLF is detected if: an upper layer indicates a failure of PC5 connection establishment corresponding to a SCG and/or a SN; or after N times of retry of PC5 connection establishment corresponding to the SCG and/or SN.

In some embodiments, the failure information comprises at least one of: a SCG RLF cause related to a failure of PC5 connection establishment, an identification of the second terminal device 120-2, an identification of corresponding Scell of SCG, an identification of the relaying path, or an identification of a multipath relaying configuration.

In some embodiments, the failure information is about detection of RLF on PC5 connection by the first terminal device 120-1.

In some embodiments, the RLF is detected if RLF of a PC5 unicast link is detected and if this PC5 unicast link is corresponding to the SCG and/or SN.

In some embodiments, the failure information comprises at least one of: a RLF cause related to a sidelink failure, T400 expiry for a predetermined destination, a maximum number of consecutive HARQ DRX for a predetermined destination, an integrity check failure concerning SL-signal radio bearer SRB2 or SL-SRB3 for a specific destination, an identification of the second terminal device 120-2, an identification of corresponding Scell of SCG, an identification of the relaying path, or an identification of a multipath relaying configuration.

In some embodiments, transmitting the failure information comprises: in response to receiving a NotificaitonMessageSidelink message from the second terminal device 120-2, transmitting the failure information.

In some embodiments, a RLF is detected by the first terminal device 120-1 if the NotificaitonMessageSidelink message is received from the second terminal device 120-2 and if a PC5 unicast link, identified by a source L2 identification of the second terminal device 120-2, is corresponding to the SCG and/or SN.

In some embodiments, the failure information comprises at least one of: a RLF cause related to a Uu failure, the second terminal device 120-2 detecting Uu RLF, the second terminal device 120-2 receiving an RRCReconfiguration including the reconfiguration WithSync, the second terminal device 120-2 performing cell reselection, the second terminal device 120-2's RRC connection failure including RRC connection reject, T300 expiry, an RRC resume failure, an identification of the second terminal device 120-2, an identification of corresponding Scell of SCG, an identification of the relaying path, or an identification of a multipath relaying configuration.

In some embodiments, the first network device 110-1 comprises a MN, the second network device 110-2 comprises a SN, and wherein the second configuration message further comprises a predetermined value or an indicator indicating a virtual SN.

In some embodiments, the first network device 110-1 comprises a MN, the second network device 110-2 comprises a SN, and wherein the second configuration message only comprises the relay related configuration, or the second configuration message indicates that a spCell of the MN is set as a spCell of the SN.

In some embodiments, a first terminal device comprises a circuitry configured to: receive a second configuration message at least comprising a relay related configuration for a relaying path between a second network device 110-2 and a first terminal device 120-1 via a second terminal device 120-2, the first terminal device 120-1 having a connection with the first network device 110-1; determine whether the relaying path is to be activated at least based on the second configuration message; and in accordance with a determination that the relaying path is to be activated, perform a relaying path activation procedure.

In some embodiments, the second configuration message further comprises an indication about whether the SCG is deactivated. The circuitry is further configured to: determine that the relaying path is to be activated if the indication indicates that the relaying path is not deactivated and path related information is indicated in the relay related configuration.

In some embodiments, the circuitry is further configured to: determine that the relaying path is to be activated in response to receiving, from the first network device 110-1, an activation indication for activating the relaying path, determining that the relaying path is to be activated.

In some embodiments, the activation indication is received via at least one of the following: a MAC CN, RRC signaling, or SRAP control information.

In some embodiments, the second configuration message is received via a RRC signaling.

In some embodiments, the circuitry is further configured to: transmit, to the first network device 110-1, a second configuration complete message corresponding to the second configuration message.

In some embodiments, the circuitry is further configured to: apply the relaying related configuration for data transmission; request an upper layer to initiate PC5 connection establishment with the second terminal device 120-2; and indicate to a lower layer that the relaying path is activated or a SCG is activated with the relaying path.

In some embodiments, the first network device 110-1 comprises a MN, the second network device 110-2 comprises a SN, wherein the second configuration message further comprises a predetermined value or an indicator indicating a virtual SN. The circuitry is further configured to: use configurations for the first network device 110-1 as configurations for the second network device 110-2.

In some embodiments, the first network device 110-1 comprises a MN, the second network device 110-2 comprises a SN, wherein the second configuration message only comprises the relay related configuration or the second configuration message indicates that a spCell of the MN is set as a spCell of the SN. the circuitry is further configured to: use configurations for the first network device 110-1 as configurations for the second network device 110-2.

In some embodiments, the circuitry is further configured to: release a PC5-RRC connection for the relaying path in response to receiving, from the first network device 110-1, a deactivation indication for deactivating a relaying path.

In some embodiments, the circuitry is further configured to: suspend a transmission via a PC5 connection of the relaying path and control reception and transmission of a discovery message in response to receiving, from the first network device 110-1, a deactivation indication for deactivating a relaying path including a separate indicator for controlling the reception and transmission of a discovery message.

In some embodiments, the circuitry is further configured to: transmit, to the first network device 110-1, failure information associated with the relaying path.

In some embodiments, the failure information is about SCG RLF during configuration procedure of the relaying path.

In some embodiments, the SCG RLF is detected if: an upper layer indicates a failure of PC5 connection establishment corresponding to a SCG and/or a SN; or after N times of retry of PC5 connection establishment corresponding to the SCG and/or SN.

In some embodiments, the failure information comprises at least one of: a SCG RLF cause related to a failure of PC5 connection establishment, an identification of the second terminal device 120-2, an identification of corresponding Scell of SCG, an identification of the relaying path, or an identification of a multipath relaying configuration.

In some embodiments, the failure information is about detection of RLF on PC5 connection by the first terminal device 120-1.

In some embodiments, the RLF is detected if RLF of a PC5 unicast link is detected and if this PC5 unicast link is corresponding to the SCG and/or SN.

In some embodiments, the failure information comprises at least one of: a RLF cause related to a sidelink failure, T400 expiry for a predetermined destination, a maximum number of consecutive HARQ DTX for a predetermined destination, an integrity check failure concerning SL-SRB2 or SL-SRB3 for a specific destination, an identification of the second terminal device 120-2, an identification of corresponding Scell of SCG, an identification of the relaying path, or an identification of a multipath relaying configuration.

In some embodiments, the circuitry is further configured to: transmit the failure information in response to receiving a NotificaitonMessageSidelink message from the second terminal device 120-2.

In some embodiments, a RLF is detected if the NotificaitonMessageSidelink message is received from the second terminal device 120-2 and if a PC5 unicast link, identified by a source L2 identification of the second terminal device 120-2, is corresponding to the SCG and/or SN.

In some embodiments, the failure information comprises at least one of: a RLF cause related to a Uu failure, the second terminal device 120-2 detecting Uu RLF, the second terminal device 120-2 receiving an RRCReconfiguration including the reconfiguration WithSync, the second terminal device 120-2 performing cell reselection, the second terminal device 120-2's RRC connection failure including RRC connection reject, T300 expiry, RRC resume failure, an identification of the second terminal device 120-2, an identification of corresponding Scell of SCG, an identification of the relaying path, or an identification of a multipath relaying configuration.

In some embodiments, a networ device comprises a circuitry configured to: receive information on a list of relay terminal devices from a first network device 110-1; and transmit, to the first network device 110-1, a first configuration message at least comprising a relay related configuration for a relaying path between the second network device 110-2 and a first terminal device 120-1 via a second terminal device 120-2, the first terminal device 120-1 having a connection with the first network device 110-1, wherein at least the relay related configuration being used by the first terminal device 120-1 to activate the relaying path.

In some embodiments, the circuitry is further configured to: transmit, to the second terminal device 120-2, a configuration message associated with the relaying path.

In some embodiments, the configuration message comprises at least one of: a local identification or an L2 identification of the second terminal device 120-2, an Uu and PC5 Relay RLC channel configuration for relaying, bearer mapping configuration, or an identification of the relaying path.

In some embodiments, the configuration message comprises an indication whether the configuration for the second terminal device 120-2 is to be activated.

In some embodiments, if SCG activation is configured with SN addition, the second network device 110-2 transmits the configuration message to the second terminal device 120-2.

In some embodiments, the first network device 110-1 comprises a MN, the second network device 110-2 comprises a SN. the circuitry is further configured to: receive the information on the list of relay terminal devices in an SN addition request, and transmits the first configuration message in an SN addition request acknowledgement message.

In some embodiments, the first network device 110-1 comprises a MN, the second network device 110-2 comprises a SN. the circuitry is further configured to: receive the information on the list of relay terminal devices in an SN modification request, and transmits the first configuration message in an SN modification request acknowledgement message.

In some embodiments, the first network device 110-1 comprises a source MN, the second network device 110-2 comprises a target MN. the circuitry is further configured to: receive the information on the list of relay terminal devices in a handover request, and transmits the first configuration message in a handover request acknowledgement message.

In some embodiments, the first network device 110-1 comprises a source MN, the second network device 110-2 comprises a target SN which is to be changed from a source SN. the circuitry is further configured to: receive from a target MN, the information on the list of relay terminal devices in a handover request, the information on the list of relay terminal devices being transmitted from the target MN to the target SN in an SN addition request. The circuitry is further configured to: transmit, to the target MN, the first configuration message in a handover request acknowledgement message, the first configuration message being received at the target MN from the target SN in an SN addition request acknowledgement message.

In some embodiments, a terminal device comprises a circuitry configured to: receive a configuration message associated with a relaying path between the second network device 110-2 and a first terminal device 120-1 via the second terminal device 120-2 from a second network device 110-2, the first terminal device 120-1 having a connection with the first network device 110-1, the first terminal device 120-1 activating the relaying path based on relay related configuration for the relaying path received from the first network device 110-1.

In some embodiments, the configuration message comprises at least one of: a local identification or an L2 identification of the second terminal device 120-2, an Uu and PC5 Relay RLC channel configuration for relaying, bearer mapping configuration, or an identification of the relaying path.

In some embodiments, the configuration message comprises an indication whether the configuration for the second terminal device 120-2 is to be activated.

In some embodiments, configuration of the relaying path of the second terminal device 120-2 is configured or activated after the first terminal device 120-1 activates the relaying path.

In some embodiments, a configuration of the relaying path of the second terminal device 120-2 is configured or activated upon the first terminal device 120-1 configures the relaying path. The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication, comprising: transmitting, at a first network device, information on a list of relay terminal devices to a second network device; receiving a first configuration message at least comprising a relay related configuration for a relaying path between the second network device and a first terminal device via a second terminal device, the first terminal device having a connection with the first network device; and transmitting a second configuration message at least comprising the relay related configuration to the first terminal device for activating the relaying path.

In some embodiments, the first network device comprises a master node (MN), the second network device comprises a secondary node (SN), wherein transmitting the information on the list of relay terminal devices comprises: transmitting the information on the list of relay terminal devices in an SN addition request, and wherein receiving the first configuration message comprises: receiving the first configuration message in an SN addition request acknowledgement message.

In some embodiments, the first network device comprises a MN, the second network device comprises a SN, wherein transmitting the information on the list of relay terminal devices comprises: transmitting the information on the list of relay terminal devices in an SN modification request, and wherein receiving the first configuration message comprises: receiving the first configuration message in an SN modification request acknowledgement message.

In some embodiments, the first network device comprises a source MN, the second network device comprises a target MN, wherein transmitting the information on the list of relay terminal devices comprises: transmitting the information on the list of relay terminal devices in a handover request, and wherein receiving the first configuration message comprises: receiving the first configuration message in a handover request acknowledgement message.

In some embodiments, the first network device comprises a source MN, the second network device comprises a target SN which is to be changed from a source SN, wherein transmitting the information on the list of relay terminal devices comprises: transmitting, to a target MN, the information on the list of relay terminal devices in a handover request, the information on the list of relay terminal devices being transmitted from the target MN to the target SN in an SN addition request, and wherein receiving the first configuration message comprises: receiving, from the target MN, the first configuration message in a handover request acknowledgement message, the first configuration message being received at the target MN from the target SN in an SN addition request acknowledgement message.

In some embodiments, the relay related configuration comprises at least one of the following: an identification of the second terminal device, a local identification of the first terminal device, PC5 Relay Radio Link Control (RLC) channel configuration for relay traffic, an associated end-to-end radio bearer, an identification of the relaying path, or an identification of multipath relaying configuration.

In some embodiments, the information on the list of relay terminal devices comprises at least one of the following: identifications of the list of relay terminal devices, or measurement results about the list of relay terminal devices.

In some embodiments, the method further comprises: in response to receiving from the first terminal device a second configuration complete message corresponding to the second configuration message, transmitting to the second network device a first configuration complete message corresponding to the first configuration message.

In some embodiments, the first network device comprises a MN and the second network device comprises a SN, and both of the first and second configuration complete messages comprise SN Radio Resource Control (RRC) response message for the SN.

In some embodiments, the first configuration message further comprises a Secondary Cell Group (SCG) radio resource configuration and the second configuration message further comprises the SCG radio resource configuration, and the method further comprises: determining whether a relaying path is deactivated based on the SCG radio resource configuration; in accordance with a determination that the relaying path is deactivated, transmitting to the first terminal device an activation indication for activating the relaying path.

In some embodiments, the activation indication is transmitted via at least one of the following: a Medium Access Control (MAC) Control Element (CE), RRC signaling, or Sidelink Relay Adaptation Protocol (SRAP) control information.

In some embodiments, the method further comprises: indicating lower layers that a SCG is activated with the relaying path.

In some embodiments, the method further comprises: transmitting to the first terminal device a deactivation indication for deactivating the relaying path.

In some embodiments, the method further comprises: receiving, from the first terminal device, failure information associated with the relaying path.

In some embodiments, the failure information is about SCG Radio Link Failure (RLF) during configuration procedure of the relaying path.

In some embodiments, the SCG RLF is detected if: an upper layer indicates a failure of PC5 connection establishment corresponding to a SCG and/or a SN; or after N times of retry of PC5 connection establishment corresponding to the SCG and/or SN.

In some embodiments, the failure information comprises at least one of: a SCG RLF cause related to a failure of PC5 connection establishment, an identification of the second terminal device, an identification of corresponding Scell of SCG, an identification of the relaying path, or an identification of a multipath relaying configuration.

In some embodiments, the failure information is about detection of RLF on PC5 connection by the first terminal device.

In some embodiments, the RLF is detected if RLF of a PC5 unicast link is detected and if this PC5 unicast link is corresponding to the SCG and/or SN.

In some embodiments, the failure information comprises at least one of: a RLF cause related to a sidelink failure, T400 expiry for a predetermined destination, a maximum number of consecutive hybrid automatic repeat request (HARQ) discontinuous transmission (DTX) for a predetermined destination, an integrity check failure concerning sidelink (SL)-signal radio bearer SRB2 or SL-SRB3 for a specific destination, an identification of the second terminal device, an identification of corresponding Scell of SCG, an identification of the relaying path, or an identification of a multipath relaying configuration.

In some embodiments, transmitting the failure information comprises: in response to receiving a NotificaitonMessageSidelink message from the second terminal device, transmitting the failure information.

In some embodiments, a RLF is detected by the first terminal device if the NotificaitonMessageSidelink message is received from the second terminal device and if a PC5 unicast link, identified by a source L2 identification of the second terminal device, is corresponding to the SCG and/or SN.

In some embodiments, the failure information comprises at least one of: a RLF cause related to a Uu failure, the second terminal device detecting Uu RLF, the second terminal device receiving an RRCReconfiguration including the reconfiguration WithSync, the second terminal device performing cell reselection, the second terminal device's RRC connection failure including RRC connection reject, T300 expiry, an RRC resume failure, an identification of the second terminal device, an identification of corresponding Scell of SCG, an identification of the relaying path, or an identification of a multipath relaying configuration.

In some embodiments, the first network device comprises a master node (MN), the second network device comprises a secondary node (SN), and wherein the second configuration message further comprises a predetermined value or an indicator indicating a virtual SN.

In some embodiments, the first network device comprises a master node (MN), the second network device comprises a secondary node (SN), and wherein the second configuration message only comprises the relay related configuration, or the second configuration message indicates that a spCell of the MN is set as a spCell of the SN.

In another solution, a method of communication comprises: receiving, at a first terminal device, a second configuration message at least comprising a relay related configuration for a relaying path between a second network device and a first terminal device via a second terminal device, the first terminal device having a connection with the first network device; determining whether the relaying path is to be activated at least based on the second configuration message; and in accordance with a determination that the relaying path is to be activated, performing a relaying path activation procedure.

In some embodiments, the second configuration message further comprises an indication about whether the SCG is deactivated, and wherein determining whether the relaying path is to be activated based on the second configuration message comprises: if the indication indicates that the relaying path is not deactivated and path related information is indicated in the relay related configuration, determining that the relaying path is to be activated.

In some embodiments, determining whether the relaying path is to be activated at least based on the second configuration message comprises: in response to receiving, from the first network device, an activation indication for activating the relaying path, determining that the relaying path is to be activated.

In some embodiments, the activation indication is received via at least one of the following: a Medium Access Control (MAC) Control Element (CE), RRC signaling, or Sidelink Relay Adaptation Protocol (SRAP) control information.

In some embodiments, the second configuration message is received via a RRC signaling.

In some embodiments, the method further comprises: transmitting, to the first network device, a second configuration complete message corresponding to the second configuration message.

In some embodiments, performing a relaying path activation procedure comprises at least one of: applying the relaying related configuration for data transmission; requesting an upper layer to initiate PC5 connection establishment with the second terminal device;
and indicating to a lower layer that the relaying path is activated or a SCG is activated with the relaying path.

In some embodiments, the first network device comprises a master node (MN), the second network device comprises a secondary node (SN), wherein the second configuration message further comprises a predetermined value or an indicator indicating a virtual SN, the method further comprises: using configurations for the first network device as configurations for the second network device.

In some embodiments, the first network device comprises a master node (MN), the second network device comprises a secondary node (SN), wherein the second configuration message only comprises the relay related configuration or the second configuration message indicates that a spCell of the MN is set as a spCell of the SN, the method further comprises: using configurations for the first network device as configurations for the second network device.

In some embodiments, the method further comprises: in response to receiving, from the first network device, a deactivation indication for deactivating a relaying path, releasing a PC5-RRC connection for the relaying path.

In some embodiments, the method further comprises: in response to receiving, from the first network device, a deactivation indication for deactivating a relaying path, suspending a transmission via a PC5 connection of the relaying path, and controlling reception and transmission of a discovery message with a separate indicator.

In some embodiments, the method further comprises: transmitting, to the first network device, failure information associated with the relaying path.

In some embodiments, the failure information is about SCG Radio Link Failure (RLF) during configuration procedure of the relaying path.

In some embodiments, the SCG RLF is detected if: an upper layer indicates a failure of PC5 connection establishment corresponding to a SCG and/or a SN; or after N times of retry of PC5 connection establishment corresponding to the SCG and/or SN.

In some embodiments, the failure information comprises at least one of: a SCG RLF cause related to a failure of PC5 connection establishment, an identification of the second terminal device, an identification of corresponding Scell of SCG, an identification of the relaying path, or an identification of a multipath relaying configuration.

In some embodiments, the failure information is about detection of RLF on PC5 connection by the first terminal device.

In some embodiments, the RLF is detected if RLF of a PC5 unicast link is detected and if this PC5 unicast link is corresponding to the SCG and/or SN.

In some embodiments, the failure information comprises at least one of: a RLF cause related to a sidelink failure, T400 expiry for a predetermined destination, a maximum number of consecutive HARQ DTX for a predetermined destination, an integrity check failure concerning SL-SRB2 or SL-SRB3 for a specific destination, an identification of the second terminal device, an identification of corresponding Scell of SCG, an identification of the relaying path, or an identification of a multipath relaying configuration.

In some embodiments, transmitting the failure information comprises: in response to receiving a NotificaitonMessageSidelink message from the second terminal device, transmitting the failure information.

In some embodiments, a RLF is detected if the NotificaitonMessageSidelink message is received from the second terminal device and if a PC5 unicast link, identified by a source L2 identification of the second terminal device, is corresponding to the SCG and/or SN.

In some embodiments, the failure information comprises at least one of: a RLF cause related to a Uu failure, the second terminal device detecting Uu RLF, the second terminal device receiving an RRCReconfiguration including the reconfiguration WithSync, the second terminal device performing cell reselection, the second terminal device's RRC connection failure including RRC connection reject, T300 expiry, RRC resume failure, an identification of the second terminal device, an identification of corresponding Scell of SCG, an identification of the relaying path, or an identification of a multipath relaying configuration.

In a further solution, a method of communication, comprising: receiving, at a second network device, information on a list of relay terminal devices from a first network device; and transmitting, to the first network device, a first configuration message at least comprising a relay related configuration for a relaying path between the second network device and a first terminal device via a second terminal device, the first terminal device having a connection with the first network device, wherein at least the relay related configuration being used by the first terminal device to activate the relaying path.

In some embodiments, the method further comprises: transmitting, to the second terminal device, a configuration message associated with the relaying path.

In some embodiments, the configuration message comprises at least one of: a local identification or an L2 identification of the second terminal device, an Uu and PC5 Relay RLC channel configuration for relaying, bearer mapping configuration, or an identification of the relaying path.

In some embodiments, the configuration message comprises an indication whether the configuration for the second terminal device is to be activated.

In some embodiments, transmitting the configuration message comprises: if SCG activation is configured with SN addition, transmitting the configuration message to the second terminal device.

In some embodiments, the first network device comprises a master node (MN), the second network device comprises a secondary node (SN), wherein receiving the information on the list of relay terminal devices comprises: receiving the information on the list of relay terminal devices in an SN addition request, and wherein transmitting the first configuration message comprises: transmitting the first configuration message in an SN addition request acknowledgement message.

In some embodiments, he first network device comprises a MN, the second network device comprises a SN, wherein receiving the information on the list of relay terminal devices comprises: receiving the information on the list of relay terminal devices in an SN modification request, and wherein transmitting the first configuration message comprises: transmitting the first configuration message in an SN modification request acknowledgement message.

In some embodiments, he first network device comprises a source MN, the second network device comprises a target MN, wherein receiving the information on the list of relay terminal devices comprises: receiving the information on the list of relay terminal devices in a handover request, and wherein transmitting the first configuration message comprises: transmitting the first configuration message in a handover request acknowledgement message.

In some embodiments, the first network device comprises a source MN, the second network device comprises a target SN which is to be changed from a source SN, wherein receiving the information on the list of relay terminal devices comprises: receiving, from a target MN, the information on the list of relay terminal devices in a handover request, the information on the list of relay terminal devices being transmitted from the target MN to the target SN in an SN addition request, and wherein transmitting the first configuration message comprises: transmitting, to the target MN, the first configuration message in a handover request acknowledgement message, the first configuration message being received at the target MN from the target SN in an SN addition request acknowledgement message.

In a further solution, a method of communication, comprising: receiving, at a second terminal device and from a second network device, a configuration message associated with a relaying path between the second network device and a first terminal device via the second terminal device, the first terminal device having a connection with the first network device, the first terminal device activating the relaying path based on relay related configuration for the relaying path received from the first network device.

In some embodiments, the configuration message comprises at least one of: a local identification or an L2 identification of the second terminal device, an Uu and PC5 Relay RLC channel configuration for relaying, bearer mapping configuration, or an identification of the relaying path.

In some embodiments, the configuration message comprises an indication whether the configuration for the second terminal device is to be activated.

In some embodiments, a configuration of the relaying path of the second terminal device is configured or activated after the first terminal device activates the relaying path. In some embodiments, a configuration of the relaying path of the second terminal device is configured or activated upon the first terminal device configures the relaying path.

In another solution, a device of communication comprises: a processor configured to cause the device to perform any of the methods above. In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
transmitting, at a first network device, information on a list of relay terminal devices to a second network device;
receiving a first configuration message at least comprising a relay related configuration for a relaying path between the second network device and a first terminal device via a second terminal device, the first terminal device having a connection with the first network device; and
transmitting a second configuration message at least comprising the relay related configuration to the first terminal device for activating the relaying path.

2. The method of claim 1, wherein the first network device comprises a master node (MN), the second network device comprises a secondary node (SN),
wherein transmitting the information on the list of relay terminal devices comprises:
transmitting the information on the list of relay terminal devices in an SN addition request, and
wherein receiving the first configuration message comprises: receiving the first configuration message in an SN addition request acknowledgement message.

3. The method of claim 1, wherein the relay related configuration comprises at least one of the following:
an identification of the second terminal device, a local identification of the first terminal device, PC5 Relay Radio Link Control (RLC) channel configuration for relay traffic, an associated end-to-end radio bearer, an identification of the relaying path, or an identification of multipath relaying configuration.

4. The method of claim 1, wherein the information on the list of relay terminal devices comprises at least one of the following: identifications of the list of relay terminal devices, or measurement results about the list of relay terminal devices.

5. The method of claim 1, further comprising: transmitting to the first terminal device an activation indication for activating the relaying path.

6. The method of claim 5, wherein the activation indication is transmitted via at least one of the following: a Medium Access Control (MAC) Control Element (CE), RRC signaling, or Sidelink Relay Adaptation Protocol (SRAP) control information.

7. The method of claim 1, further comprising:
transmitting to the first terminal device a deactivation indication for deactivating the relaying path.

8. The method of claim 1, wherein the first network device comprises a master node (MN), the second network device comprises a secondary node (SN), and wherein the second configuration message further comprises a predetermined value or an indicator indicating a virtual SN.

9. The method of claim 1, wherein the first network device comprises a master node (MN), the second network device comprises a secondary node (SN), and wherein the second configuration message only comprises the relay related configuration, or the second configuration message indicates that a spCell of the MN is set as a spCell of the SN.

10. A method of communication, comprising:
receiving, at a first terminal device, a second configuration message at least comprising a relay related configuration for a relaying path between a second network device and a first terminal device via a second terminal device, the first terminal device having a connection with the first network device;
determining whether the relaying path is to be activated at least based on the second configuration message; and
in accordance with a determination that the relaying path is to be activated, performing a relaying path activation procedure.

11. The method of claim 10, wherein the second configuration message further comprises an indication about whether the SCG is deactivated, and wherein determining whether the relaying path is to be activated based on the second configuration message comprises:
if the indication indicates that the relaying path is not deactivated and path related information is indicated in the relay related configuration, determining that the relaying path is to be activated.

12. The method of claim 10, wherein determining whether the relaying path is to be activated at least based on the second configuration message comprises:
in response to receiving, from the first network device, an activation indication for activating the relaying path, determining that the relaying path is to be activated.

13. The method of claim 12, wherein the activation indication is received via at least one of the following: a Medium Access Control (MAC) Control Element (CE), RRC signaling, or Sidelink Relay Adaptation Protocol (SRAP) control information.

14. The method of claim 10, wherein performing a relaying path activation procedure comprises at least one of:
applying the relaying related configuration for data transmission;
requesting an upper layer to initiate PC5 connection establishment with the second terminal device; and
indicating to a lower layer that the relaying path is activated or a SCG is activated with the relaying path.

15. The method of claim 10, wherein the first network device comprises a master node (MN), the second network device comprises a secondary node (SN), wherein the second configuration message further comprises a predetermined value or an indicator indicating a virtual SN, the method further comprises:
using configurations for the first network device as configurations for the second network device.

16. The method of claim 10, wherein the first network device comprises a master node (MN), the second network device comprises a secondary node (SN), wherein the second configuration message only comprises the relay related configuration or the second configuration message indicates that a spCell of the MN is set as a spCell of the SN, the method further comprises:
using configurations for the first network device as configurations for the second network device.

17. The method of claim 10, further comprising:
in response to receiving, from the first network device, a deactivation indication for deactivating a relaying path, releasing a PC5-RRC connection for the relaying path.

18. The method of claim 26, further comprising:
in response to receiving, from the first network device, a deactivation indication for deactivating a relaying path, suspending a transmission via a PC5 connection of the relaying path, and
controlling reception and transmission of a discovery message with a separate indicator.

19. A method of communication, comprising:
receiving, at a second network device, information on a list of relay terminal devices from a first network device; and
transmitting, to the first network device, a first configuration message at least comprising a relay related configuration for a relaying path between the second network device and a first terminal device via a second terminal device, the first terminal device having a connection with the first network device, wherein at least the relay related configuration being used by the first terminal device to activate the relaying path.

20. A method of communication, comprising:
receiving, at a second terminal device and from a second network device, a configuration message associated with a relaying path between the second network device and a first terminal device via the second terminal device, the first terminal device having a connection with the first network device, the first terminal device activating the relaying path based on relay related configuration for the relaying path received from the first network device.
